(19) United States
(12) Patent Application Publication
(10) Pub. No.: US 2009/0004981 A1
(43) Pub. Date: Jan. 1, 2009

(54) HIGH EFFICIENCY DIGITAL TRANSMITTER INCORPORATING SWITCHING POWER SUPPLY AND LINEAR POWER AMPLIFIER

(75) Inventors: Oren E. Eliezer, Plano, TX (US); Gennady Feygin, Plano, TX (US); Jaimin Mehta, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 12/147,477

(22) Filed: Jun. 27, 2008

Related U.S. Application Data
(60) Provisional application No. 60/946,545, filed on Jun. 27, 2007.

(51) Int. Cl. H04B 1/04

(52) U.S. Cl. 455/127.1

(57) ABSTRACT

A novel apparatus and method of improving the power efficiency of a digital transmitter for non-constant-amplitude modulation schemes. The power efficiency improvement mechanism of the invention leverages the high efficiency of a switched-mode power supply (SMPS) that supplies the high DC current to the transmitter's power amplifier, while compensating for its limitations using predistortion. The predistortion may be achieved using any suitable technique such as digital signal processing, hardware techniques, etc. A switched mode power supply (i.e. switching regulator) is used to provide a slow form (i.e. reduced bandwidth) of envelope tracking (based on a narrower bandwidth distorted version of the envelope waveform) such that the switching regulator can use a lower switching rate corresponding to the lower bandwidth, thereby obtaining high efficiency in the switching regulator. The resulting AM-AM and AM-PM distortions in the power amplifier are compensated through predistortion of the digital amplitude modulating signal which dictates the envelope at the PA input. Similarly, the phase modulation is also compensated prior to the PA, such that once it undergoes the distortion in the PA, the end result is sufficiently close to the desired phase.

### REFERENCE TO PRIORITY APPLICATION

This application claims priority to U.S. Provisional Application Ser. No. 60/946,545, filed Jun. 27, 2007, entitled “Power Efficient Digital Transmitter”, incorporated herein by reference in its entirety.

### FIELD OF THE INVENTION

The present invention relates to the field of data communications and more particularly relates to a power efficient digital transmitter that incorporates a linear amplifier and switched mode power supply.

### BACKGROUND OF THE INVENTION

In the rapidly expanding market of wireless mobile devices, the demand for more power efficient RF transceivers is ever increasing. The efficiency of the final stage power amplification in transmitters has a very significant impact on the overall power efficiency and on the battery life of the device. High efficiency power amplifiers (PAs) are thus critical in portable battery-operated wireless communications due to the fact that they typically dominate the overall power consumption of the device.

In the many prior art radios, however, the power amplifier and its related power supply or regulator are the biggest wasters of battery energy. In addition, both these components create a significant amount of heat dissipation. Users feel this heat when they hold the cellular phone against their ear leading to user discomfort. Another problem is discoloration of plastic components on the body of the cellular phone that occurs over time from the large amount of heat dissipated. This is especially a problem with lighter colored phones wherein the heat causes a yellowing of the plastic over time.

In order to maximize efficiency of the power amplifier in a non-constant amplitude modulation scheme, the voltage supply must be modulated according to the amplitude as in a fully saturated/polar PA design. Ideally, the adjustment of the power supply should be based on a switched regulator in order to minimize power dissipation in the regulator. A problem with this approach, however, is that switched power regulators cannot easily accommodate the wide bandwidth of the envelope signal which requires very high switching rates resulting in a significant loss in efficiency.

The use of non-saturated linear power amplifiers at a fixed supply voltage without any gain or output power regulation is the most wasteful and least efficient. This is because of the need to maintain biasing currents to keep the device in the linear range whereby the signal is allowed to fluctuate around that bias, as is well known from small signal theory. Thus, the most linear amplifiers are the least efficient due to the need to maintain biasing conditions. Thus, it is preferable to use a saturated power amplifier to maximize efficiency.

A prior art scheme for improving the efficiency of transmitters is known as envelope elimination and restoration (EER). A block diagram illustrating a first example prior art envelope elimination and restoration (EER) scheme is shown in FIG. 1. The circuit, generally referenced 10, comprises an amplitude detector 11, envelope amplifier 12, delay line 13 and class D/E power amplifier 14. The EER scheme improves transmitter efficiency by driving the radio frequency (RF) transistor (i.e. PA 14) in switch mode (Class D/E mode) with a constant amplitude phase-modulated signal and superimposing the envelope signal at the collector/drain of the RF transistor. The efficient envelope amplifier 12 is critical to the EER system since the total system efficiency is the product of the envelope amplifier efficiency and RF transistor drain efficiency, expressed as

ηₜₒₜₐₗ=η_{envelope amp}·η_{RF transistor} (1)

Modern complex envelope modulation schemes such as those used in Enhanced Data rates for GSM Evolution (EDGE), Wideband Code Division Multiple Access (WCDMA), Bluetooth-Enhanced Data Rate (BT-EDR), Wireless Local Area Network (WLAN), Worldwide Interoperability for Microwave Access (WiMAX), etc. typically require high fidelity and high efficiency amplification of wideband high peak-to-average (PAR) envelope signals. This imposes strict performance requirements on transceivers developed to support these modulation schemes, especially wireless handset transmitters. Stringent performance requirements for many aspects of polar transmitters exist as well.

A circuit diagram illustrating an example prior art polar transmitter employing complex modulation based on direct phase and amplitude modulation is shown in FIG. 2. The circuit, generally referenced 15, comprises a coder 16, I and Q TX filters 17, 18, polar coordinate converter 19, local oscillator 21 and multiplier 20.

In operation, the bits bₖ to be transmitted are input to the coder, which functions to generate I (real) and Q (imaginary) symbols therefrom according to the targeted communications standard. The I and Q symbols are pulse-shaped and the resulting baseband signals are converted to phase (Ang{s(t)}), and magnitude (Mag{s(t)}) baseband signals by the polar coordinate converter 19, often referred to as ‘CORDIC’. The phase data is used to control the local oscillator 21 to generate the appropriate frequency signal, which is multiplied in multiplier/mixer 20 by the magnitude data resulting in the output RF signal x(t). It is noted that this polar modulation scheme is better suited for digital implementation rather than analog implementation.

A number of modern spectrally efficient enhanced data rate modulation techniques use combined amplitude and phase/frequency modulations. Due to the large envelope fluctuations that are possible, such modulation schemes place additional constraints on the transmitter devices. Transmitting modulated signals with high peak to average power ratio (PAR) through nonlinear devices causes undesired spectral re-growth, potentially violating the transmission spectral mask defined in the related standard and/or regulations. The use of linearized power amplifiers in the transmitters is thus required to meet the spectral requirements of many wireless standards.

A block diagram illustrating a second example prior art envelope elimination and restoration (EER) scheme is shown in FIG. 3. The circuit, generally referenced 24, comprises an amplitude and phase generator (i.e. DSP signal source) 25, class S-modulator (i.e. switching modulator) 26, modulator/multiplier 27, local oscillator 28 and a saturated power amplifier (PA) 29.

First, amplitude and phase information of the voice/data input RF signal is separated via the DSP block 25. The amplitude and phase signals may also be provided by the output of the polar coordinate computation block 19 (FIG. 2). The EER scheme 24 comprising the saturated PA 29 and an S-modulator 26 is an efficient solution for power amplification for RF transmitters. The envelope (i.e. amplitude) E(t) is fed to the input of a power efficient class S-modulator 26 while the phase information of the RF signal is fed to the input of an efficient saturated power amplifier (PA) 29. The output of the S-modulator controls the power supply 29 and hence the amplitude of the output of the saturated PA. Thus, the phase and the amplitude information are combined in the saturated PA and the desired signal amplification is achieved at the RF output. An efficiency improvement is attained using EER compared to other linear amplification schemes.

There are, however, several disadvantages of the EER scheme presented above. A first disadvantage is the switching losses in the class-S modulator. The switching losses in the class S-modulator increase with the frequency of switching, which is typically one order higher than the highest frequency f_{H-env} of the input envelope. With the emergence of new broadband wireless standards such as WiMax and WLAN, f_{H-env} is increasing as well. For example, the value of f_{H-env} for WiMax is approximately 20 MHz. Note that, as a rule of thumb, the envelope bandwidth must be at least twice the RF bandwidth. The switching losses in a class S-modulator for modern broadband standards as WiMax, WLAN, etc. would be too high to yield any efficiency improvement via the class S-modulator in EER. Moreover, the high switching rate would introduce higher switching noise in the spectrum.

A second disadvantage is the low power added efficiency (PAE). Maintaining the same high constant amplitude for the input RF drive signal is disadvantageous to the power added efficiency (PAE) at low output power levels.

A third disadvantage is the ‘zero-crossing output contamination’ whereby the feed-through from the input RF drive signal having constant amplitude often contaminates the output modulated waveform near the zero-crossings in the envelope modulation.

A fourth disadvantage is that the power supply rejection ratio (PSRR) for a saturated PA is very low. When a saturated PA is operated where the output signal swings from rail to rail, if the rail is modulated, it is fluctuating with any noise present. Instantaneously, the signal increases to the rail, but if the rail changes from one moment to the next within the noise, then the RF is modulated directly by that noise with no PSRR whatsoever. Thus, a major drawback in a system that operates with a perfectly saturated amplifier is that whatever noise is experienced on the supply appears up-converted at the output unsuppressed.

Several prior art approaches to improving the efficiency of the transmitter are presented below. In a first prior art approach, a linear PA is used which is driven by a modulated signal. The linear PA has sufficient backoff to prevent nonlinear effects that would distort the output signal. This approach, however, is not energy efficient, since the PA is forced to operate at low efficiency in order to avoid distortion being generated.

In a second prior art approach, an enhancement of the first prior art approach described above, the backoff is reduced in order to increase efficiency and the resultant distortion is compensated for in an open-loop feed-forward manner (based on characterization) or by using a closed-loop system (negative feedback based on the detection of the signal at the output of the PA) to compensate for the internal modulation. The efficiency achieved in such scheme, however, would still be limited and the complexity can be considerably high.

In a third prior art approach, a linear regulator is used to drive a saturated/polar PA where the instantaneous amplitude of the RF signal is dictated solely by the regulator's output voltage. In this approach, the efficiency in the PA is maximized, since it is fully saturated at all times. Energy is wasted within the regulator, however, which is proportional to the product of the instantaneous voltage drop on it and the instantaneous current it delivers to the PA. The linear regulator can more easily accommodate the wide bandwidths needed to accommodate envelope tracking and no switching noise is created. The efficiency of this scheme, however, is poor.

In a fourth prior art approach, a switched regulator is used to drive a saturated/polar PA where the instantaneous amplitude of the RF signal is dictated solely by the regulator's output voltage. As in the previous approach, the efficiency in the PA is maximized, since it is fully saturated at all times. The regulator, however, is required to follow an envelope signal, which typically has a wide bandwidth, resulting in the need for high switching rates. This creates an analog design burden and a reduction in regulator efficiency associated with losses in the parasitics within the regulator. Another negative consequence is switching noise generated by the regulator which creates undesired spectral components at the output of the PA.

In a fifth prior art approach, a switched regulator is used where its DC output is adjusted to accommodate the peak envelope in the modulated RF signal at its output. This is a slow tracking scheme wherein the DC is adjusted according to the power level for a particular packet, which varies from packet to packet, but does not track the instantaneous envelope. It offers some relief in systems where the power for a transmitter packet may be much lower than the maximal power that the system supports, since when the output power for a particular packet is low, most of the voltage drop may be experienced within the switched regulator, where the efficiency is relatively high. While operating at maximal output power, however, the power dissipated within the PA is still significant.

In a sixth prior art approach, a switched regulator is used operating at a low rate (i.e. slow tracking on a per-packet basis, or lower-bandwidth envelope tracking), such that reasonably high efficiency can be achieved, while complementing for its slow regulation with a linear regulator of high-bandwidth. Together the combination of the switched and linear regulators provide sufficiently fast envelope tracking while benefiting from the high efficiency of the switched regulator for the majority of the voltage drop. A disadvantage, however, is the additional area and cost associated with the second regulator.

There is thus a need for a power efficiency improvement mechanism that can enable a mobile transmitter to obtain high power efficiency without exceeding the allowed limits for modulation distortion and spectral emissions. The mechanism should serve to extend the talk time as well as reduce the heat dissipated during transmission in cell-phones and other mobile devices without requiring increased complexity or cost.

### SUMMARY OF THE INVENTION

The present invention is a novel apparatus and method of improving the power efficiency of a digital transmitter for non-constant-amplitude modulation schemes. The power efficiency improvement mechanism of the invention leverages the high efficiency of a switched-mode power supply (SMPS) that supplies the high DC current to the transmitter's power amplifier, while compensating for its drawbacks using predistortion. The predistortion may be achieved using any suitable technique such as digital signal processing, hardware techniques, etc. The drawbacks include primarily the switching noise created by the SMPS and the degraded efficiency at high rates of switching, which is needed to accommodate wide bandwidth input signals.

In the mechanism of the invention, a switched mode power supply (i.e. switching regulator) is used to provide a slow form (i.e. reduced bandwidth) of envelope tracking (based on a narrower bandwidth distorted version of the envelope waveform) such that the switching regulator can use a lower switching rate corresponding to the lower bandwidth, thereby obtaining high efficiency in the switching regulator.

A consequence of the reduced bandwidth envelope signal is that the envelope tracking headroom varies from one instance to another. This results in varying amounts of AM-AM and AM-PM distortions in the power amplifier (PA). The mechanism of the invention compensates these distortions through predistortion of the digital amplitude modulating signal which dictates the envelope at the PA input (i.e. the internal amplitude modulation). Similarly, the internal phase modulation is also compensated internally prior to the PA, such that once it undergoes the distortion in the PA, the end result is sufficiently close to the desired phase.

Several example embodiments are presented. In one embodiment, predistortion is not needed at all, either due to the sufficient headroom that is always maintained by the band-limited envelope signal modulating the PA supply (at the cost of compromised efficiency), or through the use of a closed-loop scheme wherein the output amplitude and phase are constantly monitored and error signals are generated therefrom to compensate for distortions that are experienced in them. In the other embodiments, predistortion is needed to compensate for the distortion caused by the reduced headroom. The predistortion may be one-dimensional and depend only on the input amplitude (or the desired output amplitude), or may be two-dimensional and depend also on the instantaneous supply to the PA.

The mechanism of the present invention is particularly suitable for use in digital transmitters and in particular, polar transmitter based systems, such as single-chip radio solutions based on Digital RF Processor or Digital Radio Processor (DRP) technology. Such systems permit the use of existing on-chip DRP resources, such as the script processor and the receiver available in the time-division duplex (TDD) mode to achieve efficient PA linearization. An example DRP based radio is described in more detail infra.

It is appreciated that the mechanism of the invention is not limited to use in an RF transmitter. The invention is capable of increasing the power efficiency of any system having a wide-bandwidth amplitude signal and a linear power amplifier. Although the invention is well-suited for use in an RF transmitter, it is not limited to only use therein.

It is also noted that the mechanism of the present invention may be implemented in a transmitter employing quadrature modulation, in which case the amplitude and phase compensation/predistortion is converted into the corresponding compensation in the I and Q branches. This DSP based approach is easily accommodated in CMOS DRP based architectures.

Several advantages of the power efficiency improvement mechanism of the present invention include: (1) simplicity in the analog circuitry wherein a single switched regulator operating at low switching rate is required; (2) high efficiency is achieved due to the use of a switched regulator which is operated at a low switching rate that maximizes its efficiency; (3) distortion and spectral compliance problems are alleviated by the use of low cost digital processing; (4) non-zero power supply rejection ratio (PSRR) is achieved in the PA due to increased headroom compared to the fully saturated prior art case; thus providing some suppression of supply noise originating from the switching regulator; and (5) the lower switching rate creates frequency spurs only in the transmitter band and not in the receiver band, where the spectral limits are stricter.

Note that many aspects of the invention described herein may be constructed as software objects that are executed in embedded devices as firmware, software objects that are executed as part of a software application on either an embedded or non-embedded computer system running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method of improving power efficiency of a transmitter having a linear power amplifier, the method comprising the step of generating a reduced bandwidth envelope signal for input to a switched mode power supply, the output of the switched mode power supply applied to the supply input of the linear power amplifier and wherein the linear power amplifier is operated in a non-saturated mode.

There is also provided in accordance with the invention, a method of improving power efficiency of a transmitter having a linear power amplifier, the method comprising the steps of generating a reduced bandwidth envelope signal for input to a switched mode power supply, the output of the switched mode power supply applied to the supply input of the linear power amplifier, wherein the linear power amplifier is operated in a non-saturated mode and compensating for power supply dependent distortions in the linear power amplifier to yield a substantially linear output therefrom.

There is further provided in accordance with the invention, a method of improving power efficiency of a transmitter incorporating a linear power amplifier and switching regulator, the method comprising the steps of generating a slowed envelope tracking signal such that a switching rate corresponding to a lower bandwidth than that of a signal input to the linear power amplifier can be used by the switching regulator, pre-distorting an amplitude modulating signal input that determines the envelope at the power amplifier and wherein the linear power amplifier is operated in a non-saturated mode of operation.

There is also provided in accordance with the invention, a method of improving the power efficiency of a transmitter incorporating a linear power amplifier and switching regulator, the method comprising the steps of generating a reduced bandwidth envelope tracking signal input to the switching regulator such that a switching rate corresponding to a lower bandwidth than that of a signal input to the linear power amplifier can be used, the output of the switching regulator input to the supply input of the linear power amplifier and pre-distorting the input to the power amplifier to compensate for supply-headroom dependent distortions in the power amplifier.

There is further provided in accordance with the invention, an apparatus for improving the efficiency of a digital transmitter incorporating a switching power supply and a linear power amplifier comprising an envelope-tracking band limited signal generator operative to generate a band-limited envelope regulator control signal input to the switching power supply and wherein the linear power amplifier is operated in a non-saturated mode of operation.

There is also provided in accordance with the invention, a power efficient transmitter comprising a transmit chain operative to generate an output transmit signal in accordance with a signal input thereto, a switched mode power supply, a linear power amplifier operated in a non-saturated mode and an envelope-tracking band limiter operative to generate a band-limited envelope control signal input to the switched mode power supply.

There is further provided in accordance with the invention, a radio comprising a phase locked loop, a transmitter coupled to the phase locked loop, the transmitter comprising a transmit chain operative to generate a output transmit signal in accordance with a signal input thereto, a switched mode power supply, a linear power amplifier operated in a non-saturated mode, an envelope-tracking band limited signal generator operative to generate a band-limited envelope regulator control signal input to the switched mode power supply, a receiver coupled to the phase locked loop and a baseband processor coupled to the transmitter and the receiver.

### BRIEF DESCRIPTION OF THE DRAWINGS

The invention is herein described, by way of example only, with reference to the accompanying drawings, wherein:

FIG. 1 is a block diagram illustrating a first example prior art envelope elimination and restoration (EER) scheme;

FIG. 2 is a block diagram illustrating an example prior art complex polar modulator with direct phase and amplitude modulation;

FIG. 3 is a block diagram illustrating a second example prior art envelope elimination and restoration (EER) scheme;

FIG. 4 is a block diagram illustrating an example single chip radio incorporating the power efficiency improvement mechanism of the present invention;

FIG. 5 is a block diagram illustrating an example ADPLL suitable for use with the power efficiency improvement mechanism of the present invention;

FIG. 6 is a simplified block diagram illustrating an example mobile communication device incorporating the power efficiency improvement mechanism of the present invention within multiple radio transceivers;

FIG. 7 is a block diagram illustrating an example linear power amplifier;

FIG. 8 is a block diagram illustrating an example linear power amplifier and related DC-DC converter for providing dynamic supply voltage;

FIG. 9 is a block diagram illustrating the example DC-DC converter in more detail;

FIG. 10 is a block diagram illustrating the example DC-DC converter with a reduced bandwidth envelope input signal;

FIG. 11 is a block diagram illustrating an example embodiment of the power efficient transmitter of the present invention;

FIG. 12 is a graph illustrating the distorted/filtered version of the RF envelope generated by the power efficiency improvement mechanism versus an original prior art envelope;

FIG. 13 is a graph illustrating the power spectral density of the complex input signal and the related envelope waveform;

FIG. 14 is a block diagram illustrating the amplitude processing components of the power efficient transmitter of the present invention in more detail;

FIG. 15 is a block diagram illustrating the phase processing components of the power efficient transmitter of the present invention in more detail;

FIG. 16 is a graph illustrating the desired envelope signal and the final band-limited interpolated signal resulting from the generation of the reduced-bandwidth envelope signal E_{BL};

FIG. 17 is a block diagram illustrating an example embodiment of the reduced bandwidth envelope signal generator circuit of the present invention;

FIG. 18 is a graph illustrating an example single dimension predistortion function with a threshold; and

FIG. 19 is a flow diagram illustrating an example predistortion LUT generation method of the present invention.

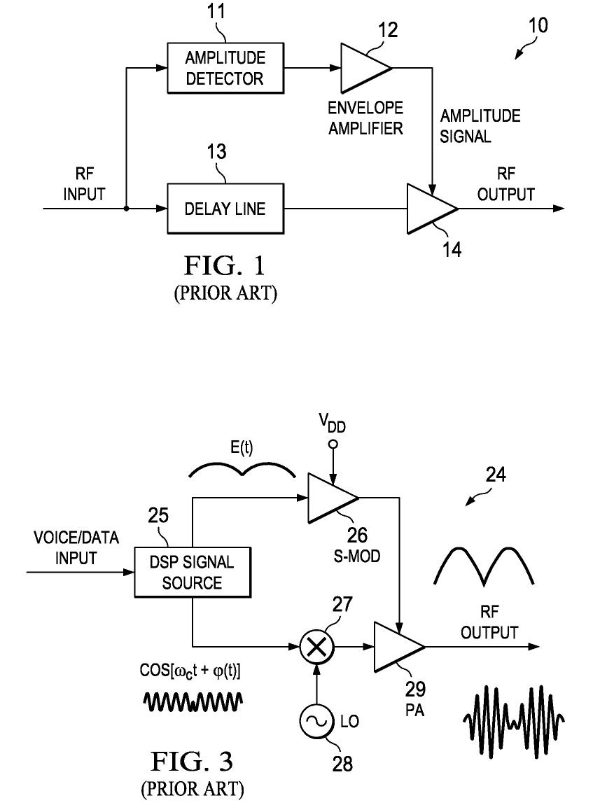

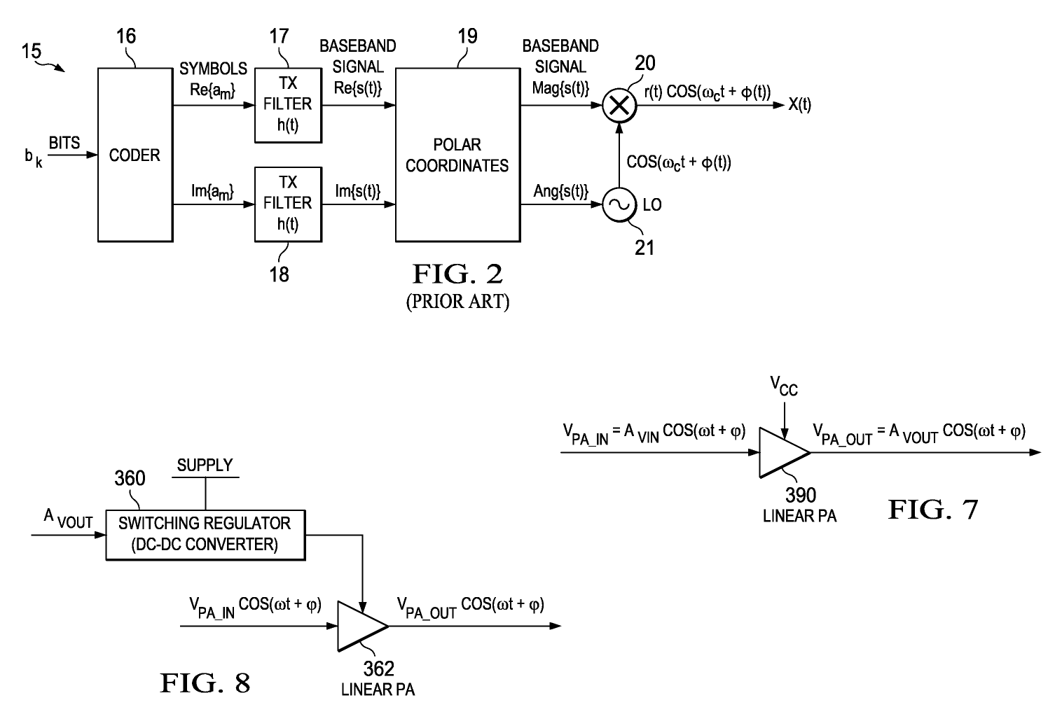

### DETAILED DESCRIPTION OF THE INVENTION

### Notation Used Throughout

The following notation is used throughout this document.

| Term | Definition |
|---|---|
| ADC | Analog to Digital Converter |
| ADPLL | All Digital Phase Locked Loop |
| AM | Amplitude Modulation |
| ARM | Acorn RISC Machine |
| ASIC | Application Specific Integrated Circuit |
| AVI | Audio Video Interface |
| BER | Bit Error Rate |
| BIST | Built-In Self Test |
| BMP | Windows Bitmap |
| BT | Bluetooth |
| BT-EDR | Bluetooth-Extended Data Rate |
| CDMA | Code Division Multiple Access |
| CMOS | Complementary Metal Oxide Semiconductor |
| CORDIC | COordinate Rotation DIgital Computer |
| CPU | Central Processing Unit |
| DAC | Digital to Analog Converter |
| DBB | Digital Baseband |
| DC | Direct Current |
| DCO | Digitally Controlled Oscillator |
| DCXO | Digitally Controlled Crystal Oscillator |
| DPA | Digital Power Amplifier |
| DRAC | Digital to RF Amplitude Conversion |
| DRP | Digital RF Processor or Digital Radio Processor |
| DSL | Digital Subscriber Line |
| DSP | Digital Signal Processing |
| EDGE | Enhanced Data rates for GSM Evolution |
| EDR | Extended Data Rate |
| EER | Envelope Elimination and Restoration |
| EPROM | Erasable Programmable Read Only Memory |
| EVM | Error Vector Magnitude |
| FCW | Frequency Command Word |
| FDD | Frequency Division Duplex |
| FEM | Front End Module |
| FM | Frequency Modulation |
| FPGA | Field Programmable Gate Array |
| FREF | Frequency Reference |
| GGE | GSM/GPRS/EDGE |
| GPRS | General Packet Radio Service |
| GPS | Global Positioning Satellite |
| GSM | Global System for Mobile Communications |
| HB | High Band |
| HDL | Hardware Description Language |
| IC | Integrated Circuit |
| IEEE | Institute of Electrical and Electronic Engineers |
| IIR | Infinite Impulse Response |
| IPM | Integrated Power Management |
| JPG | Joint Photographic Experts Group |
| LB | Low Band |
| LDO | Low Drop Out |
| LNA | Low Noise Amplifier |
| LNTA | Low Noise Transconductance Amplifier |
| LO | Local Oscillator |
| LPF | Low Pass Filter |
| LUT | Look-Up Table |
| MIM | Metal Insulator Metal |
| MOS | Metal Oxide Semiconductor |
| MP3 | MPEG-1 Audio Layer 3 |
| MPG | Moving Picture Experts Group |
| PA | Power Amplifier |
| PAE | Power-Added Efficiency |
| PAR | Peak-To-Average Ratio |
| PC | Personal Computer |
| PDA | Personal Digital Assistant |
| PLL | Phase Locked Loop |
| PM | Phase Modulation |
| PPA | Pre-Power Amplifier |
| PSRR | Power Supply Rejection Ratio |
| RAM | Random Access Memory |
| RAT | Radio Access Technoligy |
| RC | Raised Cosine |
| RCF | Rate Change Filter |
| RF | Radio Frequency |
| RFBIST | RF Built-In Self Test |
| ROM | Read Only Memory |
| RRC | Root Raised Cosine |
| RX | Receiver |
| SAW | Surface Acoustic Wave |
| SMPS | Switched Mode Power Supply |
| SoC | System on Chip |
| SPI | Serial Peripheral Interface |
| SRAM | Static Read Only Memory |
| TA | Transconductance Amplifier |
| TDC | Time-to-Digital Converter |
| TDD | Time Division Duplex |
| TX | Transmitter |
| VCO | Voltage Controlled Oscillator |
| VSWR | Voltage Standing Wave Ratio |
| WCDMA | Wideband Code Division Multiple Access |
| WiMAX | World Interoperability for Microwave Access |
| WLAN | Wireless Local Area Network |
| WMA | Windows Media Audio |
| WMV | Windows Media Video |
| WPAN | Wireless Personal Area Network |

### DETAILED DESCRIPTION OF THE INVENTION

The present invention is a novel apparatus and method for the enhancement of the efficiency in a transmitter. The mechanism is operative to power the PA with a switched-regulator based supply that follows the varying amplitude envelope of the output signal, such that sufficient headroom is maintained in the PA to avoid clipping, while efficiency is improved by dynamically minimizing this headroom.

The mechanism of the present invention is suitable for use in wireless transmitters and particularly is small-signal polar transmitter based systems, such as single-chip radio solutions based on the DRP technology. Such systems permit the use of existing on-chip DRP resources, such as the script processor and the receiver available in the time-division duplex (TDD) mode to achieve efficient PA linearization. Note that although the invention is suitable for use in a digital radio transceiver incorporating a polar transmitter it can be used in other applications as well, such as in a digital transmitter operating in Cartesian coordinates and in general communication channel and data converters. It can also be used for non-TDD mode transceivers.

To aid in understanding the principles of the present invention, the description is provided in the context of a digital RF processor (DRP) based transmitter having a polar architecture that may be adapted to comply with a particular wireless communications standard such as GSM, GPRS, EDGE, Bluetooth, WCDMA, WLAN, WiMax, etc. It is appreciated, however, that the invention is not limited to use with any particular communication standard and may be used in optical, wired and wireless applications. Further, the invention is not limited to use with a specific modulation scheme but is applicable to any modulation scheme including both digital and analog modulations.

Although the power efficiency improvement mechanism is applicable to numerous wireless communication standards and can be incorporated in numerous types of wireless or wired communication devices such a multimedia player, mobile station, user equipment, cellular phone, PDA, DSL modem, WPAN device, etc., it is described in the context of a digital RF processor (DRP) based GSM transmitter. It is appreciated, however, that the invention is not limited to use with any particular communication standard and may be used in optical, wired and wireless applications. Further, the invention is not limited to use with a specific modulation scheme but may be applicable to many digital modulation schemes where there is a need to improve the power efficiency of transmitters.

Note that throughout this document, the term communications device is defined as any apparatus or mechanism adapted to transmit, receive or transmit and receive data through a medium. The term communications transceiver or communications device is defined as any apparatus or mechanism adapted to transmit and receive data through a medium. The communications device or communications transceiver may be adapted to communicate over any suitable medium, including wireless or wired media. Examples of wireless media include RF, infrared, optical, microwave, UWB, Bluetooth, WiMAX, WiMedia, WiFi, or any other broadband medium, etc. Examples of wired media include twisted pair, coaxial, optical fiber, any wired interface (e.g., USB, Firewire, Ethernet, etc.). The term Ethernet network is defined as a network compatible with any of the IEEE 802.3 Ethernet standards, including but not limited to 10Base-T, 100Base-T or 1000Base-T over shielded or unshielded twisted pair wiring. The terms communications channel, link and cable are used interchangeably. The notation DRP is intended to denote either a Digital RF Processor or Digital Radio Processor. References to a Digital RF Processor infer a reference to a Digital Radio Processor and vice versa.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.). The user input means is typically formed of one or more manually operated switches, buttons, wheels or other user input means. Examples of multimedia devices include pocket sized personal digital assistants (PDAs), personal media player/recorders, cellular telephones, handheld devices, and the like.

The amplitude of the input voltage signal V_{PA}_{_{—}}_{IN} of the power amplifier (PA) typically varies with time and is denoted A_{Vin}. Similarly, the amplitude of the output voltage signal V_{PA}_{_{—}}_{OUT} also varies with time and is denoted A_{Vout}. The difference between the PA supply voltage V_{CC} and A_{Vout} is defined as the output voltage headroom or simply headroom.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### Single Chip Radio

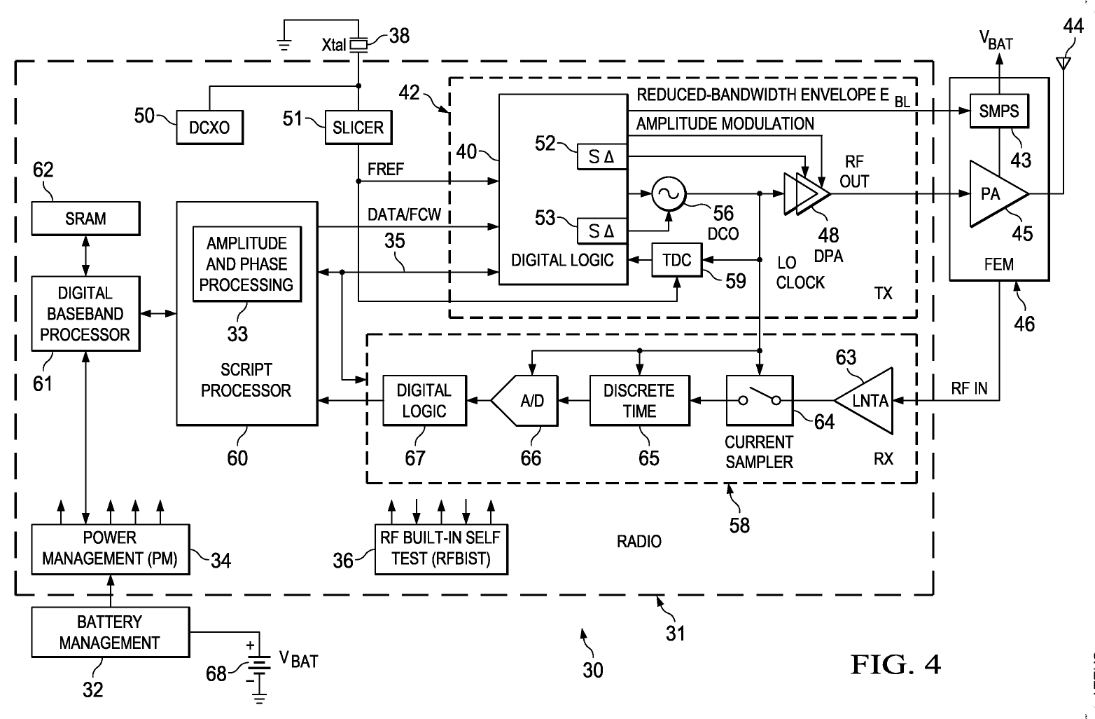

A block diagram illustrating an example single chip radio incorporating the power efficiency improvement mechanism of the present invention is shown in FIG. 4. Note that the mechanism (or a portion thereof) may be implemented as a software routine within the processor serving as the transceiver controller. For illustration purposes only, the transmitter, as shown, is adapted for the GSM/EDGE cellular standards. It is appreciated, however, that one skilled in the communication arts can adapt the transmitter illustrated herein to other modulations and communication standards as well without departing from the spirit and scope of the present invention.

The radio circuit, generally referenced 30, comprises a single chip radio integrated circuit (IC) 31 coupled to a crystal 38, front end module (FEM) 46, antenna 44 and battery management circuit 32 connected to a battery 68. The FEM 46 comprises a switched mode power supply (e.g., a switching regulator) 43 and power amplifier (PA) 45 coupled to the antenna 44. The radio chip 31 comprises a script processor 60, digital baseband (DBB) processor 61, memory 62 (e.g., static RAM), TX block 42, RX block 58, digitally controlled crystal oscillator (DCXO) 50, slicer 51, power management unit 34 and RF built-in self test (BIST) 36. The TX block comprises high speed and low speed digital logic block 40 including ΣΔ modulators 52, 53, digitally controlled oscillator (DCO) 56, TDC 59 and digitally controlled power amplifier (DPA) or pre-power amplifier (PPA) 48. The ADPLL and transmitter generate various radio frequency signals. The RX block comprises a low noise transconductance amplifier 63, current sampler 64, discrete time processing block 65, analog to digital converter (ADC) 66 and digital logic block 67 for the digital processing of the recovered signal in the receiver.

In accordance with the invention, the radio comprises an amplitude and phase predistortion alignment function 33 operative to provide AM/AM and AM/PM domain predistortion to the signal input to the PA. The predistortion is applied so as to compensate for the distortion and spectral compliance problems generated by the switching regulator.

The structure presented herein has been used to develop three generations of a Digital RF Processor (DRP) for single-chip Bluetooth, GSM and GSM/EDGE radios realized in 130 nm, 90 nm and 65 nm digital CMOS process technologies, respectively. The common architecture is highlighted in FIG. 4 with features added specific to the cellular radio, such as the DCXO. The all digital phase locked loop (ADPLL) based transmitter employs a polar architecture with all digital phase/frequency and amplitude modulation paths. The receiver employs a discrete-time architecture in which the RF signal is directly sampled and processed using analog and digital signal processing techniques.

A key component is the digitally controlled oscillator (DCO) 56, which avoids any analog tuning controls. A digitally-controlled crystal oscillator (DCXO) generates a high-quality base-station-synchronized frequency reference such that the transmitted carrier frequencies and the received symbol rates are accurate to within 0.1 ppm. Digital logic built around the DCO realizes an all-digital PLL (ADPLL) that is used as a local oscillator for both the transmitter and the receiver. The polar transmitter architecture utilizes the wideband direct frequency modulation capability of the ADPLL and a digitally controlled power amplifier (DPA) 48 for the amplitude modulation. The DPA operates in near-class-E mode and uses an array of nMOS transistor switches to regulate the RF amplitude and acts as a digital-to-RF amplitude converter (DRAC). It is followed by a matching network and an external front-end module 46, which comprises a power amplifier (PA) 45, a transmit/receive switch for the common antenna 44 (not shown) and RX surface acoustic wave (SAW) filters (not shown). Fine amplitude resolution is achieved through high-speed ΣΔ dithering of the DPA nMOS transistors.

Amplitude modulation may also be realized through the use of a DAC that is fed with the digital representation of the envelope signal, followed by a low-pass reconstruction filter and a mixer, where the envelope signal is multiplied with the phase-modulated signal. Furthermore, the complex modulated signal may also be realized using the well-known quadrature structure (i.e. in Cartesian coordinates) either with analog circuitry or fully digital circuitry.

The receiver 58 employs a discrete-time architecture in which the RF signal is directly sampled at the Nyquist rate of the RF carrier and processed using analog and digital signal processing techniques. The transceiver is integrated with a script processor 60, dedicated digital base band processor 61 (i.e. ARM family processor or DSP) and SRAM memory 62. The script processor handles various TX and RX calibration, compensation, sequencing and lower-rate data path tasks and encapsulates the transceiver complexity in order to present a much simpler software programming model. In addition, in accordance with the invention, the script processor is also operative to execute the power efficiency improvement mechanism as a software task.

The frequency reference (FREF) is generated on-chip by a 26 MHz (could be 38.4 MHz or other) digitally controlled crystal oscillator (DCXO) 50 coupled to slicer 51. An integrated power management (PM) system is connected to an external battery management circuit 32 that conditions and stabilizes the supply voltage. The PM comprises multiple low drop out (LDO) regulators that provide internal supply voltages and also isolate supply noise between circuits. The RF built-in self-test (RFBIST) 36 performs autonomous phase noise and modulation distortion testing, and various loopback configurations for transmitter and receiver tests. The transceiver is integrated with the digital baseband and SRAM in a complete system-on-chip (SoC) solution. Almost all the clock signals on this SoC are derived from and are synchronous to the RF oscillator clock. This helps to reduce susceptibility to the noise generated through clocking of the massive digital logic.

The example transmitter comprises a polar architecture in which the amplitude and phase/frequency modulations are implemented in separate paths. Transmitted symbols generated in the digital baseband (DBB) processor are first pulse-shape-filtered in the Cartesian coordinate system. The filtered in-phase (I) and quadrature (Q) samples are then converted through a CORDIC algorithm into amplitude and phase samples of the polar coordinate system. The phase is then differentiated to obtain frequency deviation. The polar signals are subsequently conditioned through signal processing to sufficiently increase the sampling rate in order to reduce the quantization noise density and lessen the effects of the modulating spectrum replicas.

### ADPLL Based Polar Transmitter

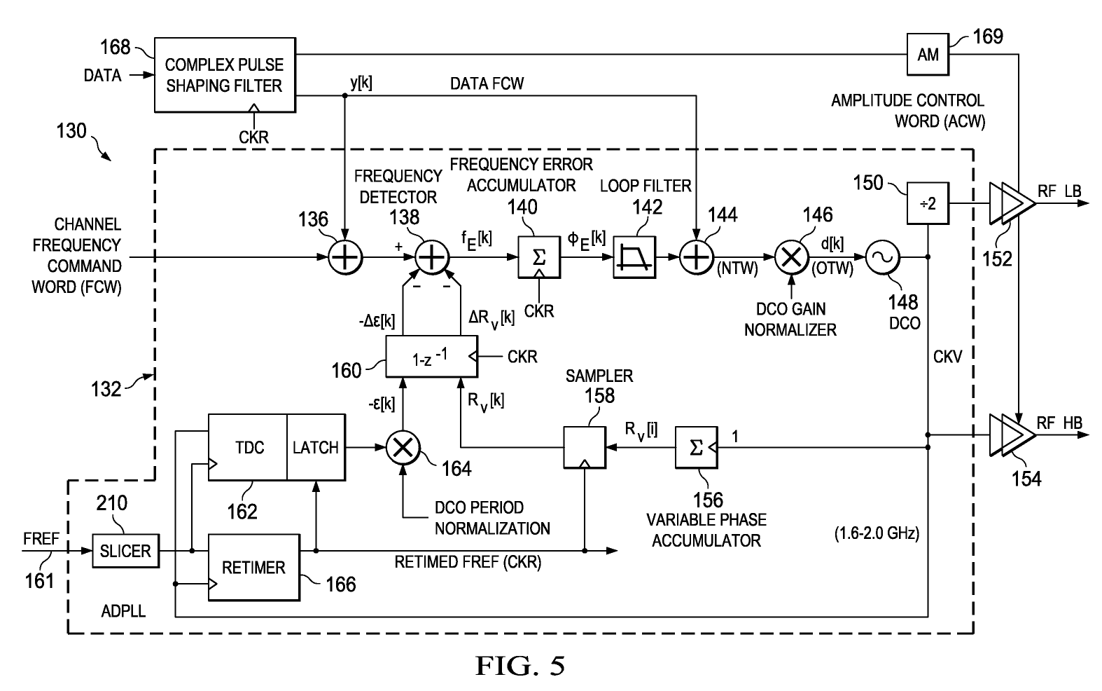

A block diagram illustrating an example ADPLL suitable for use in the power efficient RF transmitter of the present invention is shown in FIG. 5. The ADPLL presented herein is provided as an example application of the power efficient digital transmitter of the present invention. It is appreciated that the mechanism and transmitter may be applied to numerous other communication circuits as well without departing from the scope of the invention.

A more detailed description of the operation of the ADPLL can be found in U.S. Patent Publication No. 2006/0033582A1, published Feb. 16, 2006, to Staszewski et al., entitled “Gain Calibration of a Digital Controlled Oscillator,” U.S. Patent Publication No. 2006/0038710A1, published Feb. 23, 2006, to Staszewski et al., entitled “Hybrid Polar/Cartesian Digital Modulator” and U.S. Pat. No. 6,809,598, to Staszewski et al., entitled “Hybrid Of Predictive And Closed-Loop Phase-Domain Digital PLL Architecture,” all of which are incorporated herein by reference in their entirety.

For illustration purposes only, the transmitter, as shown, is adapted for the GSM/EDGE cellular standards. It is appreciated, however, that one skilled in the communication arts can adapt the transmitter illustrated herein to other modulations and communication standards as well without departing from the spirit and scope of the present invention.

The transmitter, generally referenced 130, is well-suited for a deep-submicron CMOS implementation. The transmitter comprises a complex pulse shaping filter 168, amplitude modulation (AM) block 169 and ADPLL 132. The circuit 130 is operative to perform complex modulation in the polar domain in addition to the generation of the local oscillator (LO) signal for the receiver. All clocks in the system are derived directly from this source. Note that the transmitter is constructed using digital techniques that exploit the high speed and high density of the advanced CMOS, while avoiding problems related to voltage headroom found in such process. The ADPLL circuit replaces a conventional RF synthesizer architecture (based on a voltage-controlled oscillator (VCO) and a phase/frequency detector and charge-pump combination), with a digitally controlled oscillator (DCO) 148 and a time-to-digital converter (TDC) 162. All inputs and outputs are digital and some even at multi-GHz frequency.

The core of the ADPLL is a digitally controlled oscillator (DCO) 148 adapted to generate the RF oscillator clock CKV. The oscillator core (not shown) operates at a multiple of the 1.6-2.0 GHz (e.g., 4) high band frequency or at a multiple of the 0.8-1.0 GHz low band frequency (e.g., 8). Note that typically, the multiple is a power-of-two but any other suitable integer or even fractional frequency relationship may be advantageous. The output of the DCO is then divided for precise generation of RX quadrature signals, and for use as the transmitter's carrier frequency. The single DCO is shared between transmitter and receiver and is used for both the high frequency bands (HB) and the low frequency bands (LB). In addition to the integer control of the DCO, at least 3-bits of the minimal varactor size used are dedicated for ΣΔ dithering in order to improve frequency resolution. The DCO comprises a plurality of varactor banks, which may be realized as n-poly/n-well inversion type MOS capacitor (MOSCAP) devices or Metal Insulator Metal (MIM) devices that operate in the flat regions of their C-V curves to assist digital control. The output of the DCO is a modulated digital signal at f_{RF}. This signal is input to the pre-power amplifier (PPA) 152. It is also input to the RF low band pre-power amplifier 154 after divide by two via divider 150.

The expected variable frequency f_{V} is related to the reference frequency f_{R} by the frequency command word (FCW).

$$FCW [ k ] ≡ \frac{E ( {f}_{V} [ k ] )}{{f}_{R}} \qquad ( 2 )$$

The FCW is time variant and is allowed to change with every cycle T_{R}=1/f_{R} of the frequency reference clock. With W_{F}=24 the word length of the fractional part of FCW, the ADPLL provides fine frequency control with 1.5 Hz accuracy, according to:

$$Δ {f}_{res} = \frac{{f}_{R}}{{2}^{{W}_{F}}} \qquad ( 3 )$$

The number of integer bits W₁=8 has been chosen to fully cover the GSM/EDGE and partial WCDMA band frequency range of f_{V}=1,600-2,000 MHz with an arbitrary reference frequency f_{R}≧8 MHz.

The ADPLL operates in a digitally-synchronous fixed-point phase domain as follows: The variable phase accumulator 156 determines the variable phase R_{V}[i] by counting the number of rising clock transitions of the DCO oscillator clock CKV as expressed below.

$${R}_{V} [ i ] = {\sum }_{l = 0}^{i} 1 \qquad ( 4 )$$

The index i indicates the DCO edge activity. The variable phase R_{V}[i] is sampled via sampler 158 to yield sampled FREF variable phase R_{V}[k], where k is the index of the FREF edge activity. The sampled FREF variable phase R_{V}[k] is fixed-point concatenated with the normalized time-to-digital converter (TDC) 162 output ε[k]. The TDC measures and quantizes the time differences between the frequency reference FREF and the DCO clock edges. The sampled differentiated (via block 160) variable phase is subtracted from the frequency command word (FCW) by the digital frequency detector 138. The frequency error f_{E}[k] samples

f_{E}[k]=FCW−[(R_{V}[k]−ε[k])−(R_{V}[k−1]−ε[k−1])] (5)

are accumulated via the frequency error accumulator 140 to create the phase error φ_{E}[k] samples

$${φ}_{E} [ k ] = {\sum }_{l = 0}^{k} {f}_{E} [ k ] \qquad ( 6 )$$

which are then filtered by a fourth order IIR loop filter 142 and scaled by a proportional loop attenuator α. A parallel feed with coefficient ρ adds an integrated term to create type-II loop characteristics which suppress the DCO flicker noise.

The IIR filter is a cascade of four single stage filters, each satisfying the following equation:

y[k]=(1−λ)·y[k−1]+λ·x[k] (7)

wherein

x[k] is the current input;

y[k] is the current output;

k is the time index;

λ is the configurable coefficient;

The 4-pole IIR loop filter attenuates the reference and TDC quantization noise with an 80 dB/dec slope, primarily to meet the GSM/EDGE spectral mask requirements at 400 kHz offset. The filtered and scaled phase error samples are then multiplied by the DCO gain K_{DCO} normalization factor f_{R}/\hat{K}_{DCO} via multiplier 146, where f_{R} is the reference frequency and \hat{K}_{DCO} is the DCO gain estimate, to make the loop characteristics and modulation independent from K_{DCO}. The modulating data is injected into two points of the ADPLL for direct frequency modulation, via adders 136 and 144. A hitless gear-shifting mechanism for the dynamic loop bandwidth control serves to reduce the settling time. It changes the loop attenuator a several times during the frequency locking while adding the (α₁/α₂−1)φ₁ dc offset to the phase error, where indices 1 and 2 denote before and after the event, respectively. Note that φ₁=φ₂, since the phase is to be continuous.

The frequency reference FREF is input to the retimer 166 and provides the clock for the TDC 162. The FREF input is resampled by the RF oscillator clock CKV via retimer block 166 which may comprise a flip flop or register clocked by the reference frequency FREF. The resulting retimed clock (CKR) is distributed and used throughout the system. This ensures that the massive digital logic is clocked after the quiet interval of the phase error detection by the TDC. Note that in the example embodiment described herein, the ADPLL is a discrete-time sampled system implemented with all digital components connected with all digital signals.

### Mobile Device Incorporating the Power Efficiency Improvement Mechanism

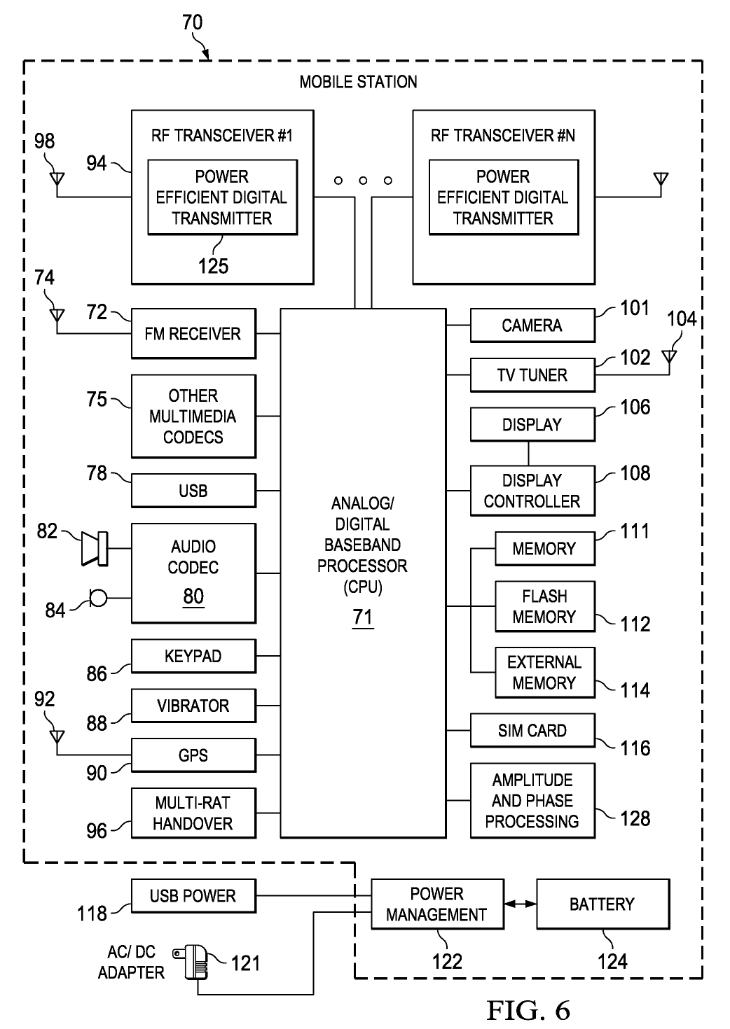

A simplified block diagram illustrating an example mobile communication device incorporating the power efficiency improvement mechanism of the present invention within multiple radio transceivers is shown in FIG. 6. Note that the mobile device may comprise any suitable wired or wireless device such as multimedia player, mobile communication device, cellular phone, smartphone, PDA, Bluetooth device, etc. For illustration purposes only, the device is shown as a mobile device, such as a cellular phone. Note that this example is not intended to limit the scope of the invention as the power efficiency improvement mechanism of the present invention can be implemented in a wide variety of communication devices.

The mobile device, generally referenced 70, comprises a baseband processor or CPU 71 having analog and digital portions. The mobile device may comprise a plurality of RF transceivers 94 and associated antennas 98. RF transceivers for the basic cellular link and any number of other wireless standards and Radio Access Technologies (RATs) may be included. Examples include, but are not limited to, Global System for Mobile Communication (GSM)/GPRS/EDGE 3G; CDMA; WiMAX for providing WiMAX wireless connectivity when within the range of a WiMAX wireless network; Bluetooth for providing Bluetooth wireless connectivity when within the range of a Bluetooth wireless network; WLAN for providing wireless connectivity when in a hot spot or within the range of an ad hoc, infrastructure or mesh based wireless LAN network; near field communications; UWB; etc. One or more of the RF transceivers may comprise additional antennas to provide antenna diversity which yields improved radio performance. The mobile device may also comprise internal RAM and ROM memory 110, Flash memory 112 and external memory 114.

Several user-interface devices include microphone(s) 84, speaker(s) 82 and associated audio codec 80 or other multimedia codecs 75, a keypad for entering dialing digits 86 and for other controls and inputs, vibrator 88 for alerting a user, camera and related circuitry 100, a TV tuner 102 and associated antenna 104, display(s) 106 and associated display controller 108 and GPS receiver 90 and associated antenna 92. A USB or other interface connection 78 (e.g., SPI, SDIO, PCI, etc.) provides a serial link to a user's PC or other device. An FM transceiver 72 and antenna 74 provide the user the ability to listen to FM broadcasts as well as the ability to transmit audio over an unused FM station at low power, such as for playback over a car or home stereo system having an FM receiver. SIM card 116 provides the interface to a user's SIM card for storing user data such as address book entries, user identification, etc.

The RF transceivers 94 also comprise transmitters 125 incorporating the power efficiency improvement mechanism of the present invention. Alternatively (or in addition to), the amplitude and phase processing portion of the power efficiency improvement mechanism may be implemented as a task 128 executed by the baseband processor 71. The power efficiency improvement blocks 125, 128 are adapted to implement the power efficiency improvement mechanism of the present invention as described in more detail infra. In operation, the power efficiency improvement mechanism may be implemented as hardware, software or as a combination of hardware and software. Implemented as a software task, the program code operative to implement the power efficiency improvement mechanism of the present invention is stored in one or more memories 110, 112 or 114 or local memories within the baseband processor.

Portable power is provided by the battery 124 coupled to power management circuitry 122. External power may be provided via USB power 118 or an AC/DC adapter 121 connected to the battery management circuitry 122, which is operative to manage the charging and discharging of the battery 124.

### Power Efficiency Improvement Mechanism

As stated supra, the present invention is a mechanism for improving the power efficiency of any system having a wide-bandwidth amplitude signal and a linear power amplifier. A block diagram illustrating an example linear power amplifier is shown in FIG. 7. The amplitude A_{Vin} of the input voltage signal V_{PA}_{_{—}}_{IN} of the power amplifier 390 typically varies with time. Consequently, the amplitude A_{Vout} of the output voltage signal V_{PA}_{_{—}}_{OUT} also varies with time. The difference between the power amplifier supply voltage V_{CC} and A_{Vout} is referred to as output voltage headroom or simply headroom, and must always be positive to avoid clipping distortion.

For near-linear amplification of the input signal, the supply voltage V_{CC} must be greater than the A_{Vout} by some margin σ at all time, i.e. the value (headroom-σ) must be positive. Otherwise, a clipping of the output waveform occurs resulting in distortion and spurious spectral components in the transmitted signal. Thus, typically, the supply voltage V_{CC} is maintained at a maximum of the expected A_{Vout} values. This results in a high value of the average headroom and low efficiency. In linear PA based solutions, such as for EDGE, a power-headroom of 6 dB is typically maintained between the output power and the saturation point of the PA in order to maintain linearity and avoid distortion.

To increase the efficiency of a linear PA in accordance with the present invention, the average headroom is minimized. Dynamic power supply modulation, i.e. dynamic variation of V_{CC}, is an effective way to improve the efficiency of a linear power amplifier. The quantity (σ=V_{CC}−A_{VOUT}) should ideally be zero at all times for maximum power efficiency in the PA. In such cases, the PA would operate in saturation at all times and would therefore be most efficient.

Typically, this kind of power supply modulation is applied to the power amplifier using a linear regulator, where the dissipated power is proportional to the dynamic headroom. Consequently, the improvement in efficiency in the PA comes at a cost of wasted power in the regulator, such that the overall efficiency of the transmitter is not maximized.

In accordance with the present invention, the linear regulator providing power to the PA is replaced with a switched regulator of much higher efficiency. In addition, the PA operates substantially linearly, rather than in saturation, with possible distortion that may be encountered at the higher peaks being compensated for by means of a dynamic predistortion function (described in more detail infra). The constant-amplitude signal input to the PA for the saturated PA scheme is therefore replaced with an amplitude modulated signal, wherein the amplitude modulation either (1) corresponds to the exact envelope that is desired at the transmitter output, or (2) is a predistorted form of it, depending on the distortion experienced in the PA.

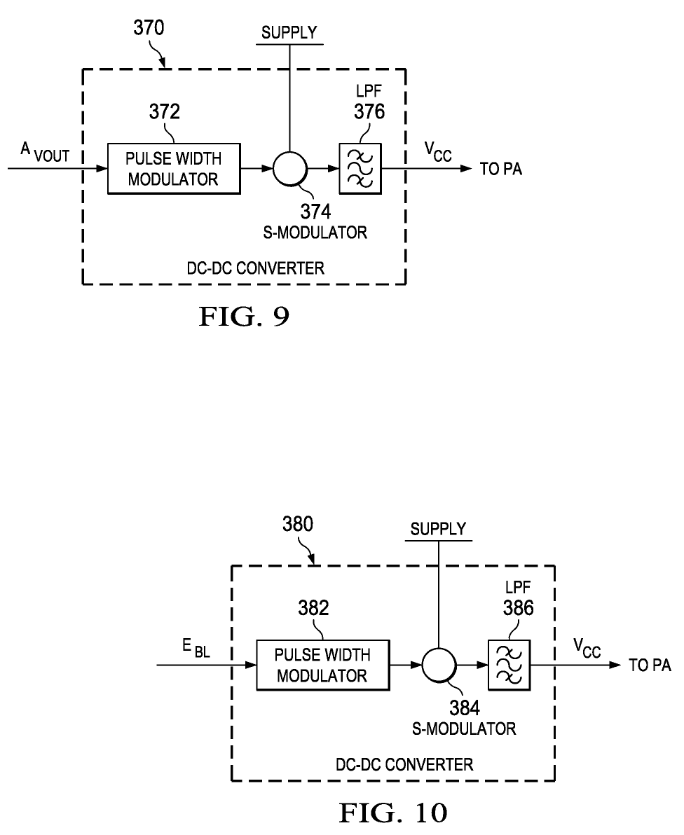

A block diagram illustrating an example linear power amplifier and related DC-DC converter for providing supply voltage is shown in FIG. 8. The DC-DC converter 360, coupled to linear power amplifier 362, also needs to be power efficient to maintain the overall power efficiency and is typically implemented using a pulse width modulator and a class-S modulator (FIG. 3). A block diagram illustrating the example DC-DC converter in more detail is shown in FIG. 9. The DC-DC converter, generally referenced 370, comprises a pulse width modulator 372, class-S modulator 374 and a low pass filter 376.

Current emerging wireless standards support much higher data-rates compared to previous generation wireless standards. This in turn necessitates the increased bandwidth of A_{Vout}. With the increased bandwidth of A_{Vout}, however, the efficiency of the DC-DC converter declines, mainly due to the significantly increased switching losses in the class-S modulator. Beyond a certain bandwidth for A_{Vout}, the losses in the DC-DC converter become greater than any power savings obtained in the power amplifier due to supply modulation. Apart from the loss in efficiency, a switching DC-DC converter cannot support more than a certain bandwidth due to the physical limitations of the device. Thus, for systems with high A_{Vout} bandwidth, the input to the DC-DC converter needs to be band-limited to frequency f_{c} in order to restrict the losses in the DC-DC converter. The frequency f_{c} is determined based on the tradeoff between the efficiency loss in the DC-DC converter and the efficiency gain due to the reduced average headroom at the output of the power amplifier.

In order to achieve this (i.e. a band-limited DC-DC converter input), it is assumed that instead of applying the A_{Vout} signal at the input of the DC-DC converter (as in FIG. 9), a band-limited envelope signal denoted E_{BL} is applied at this input instead. A block diagram illustrating the example DC-DC converter with a reduced bandwidth envelope input signal is shown in FIG. 10. As in FIG. 9, the DC-DC converter 380 comprises a pulse width modulator 382, S-modulator 382 and low pass filter 386. Note that E_{BL} is band-limited to frequency f_{c} and is derived from the desired A_{VOUT} signal, representing the actual envelope signal that the modulated output of the transmitter should follow.

### Example Power Efficient RF Transmitter

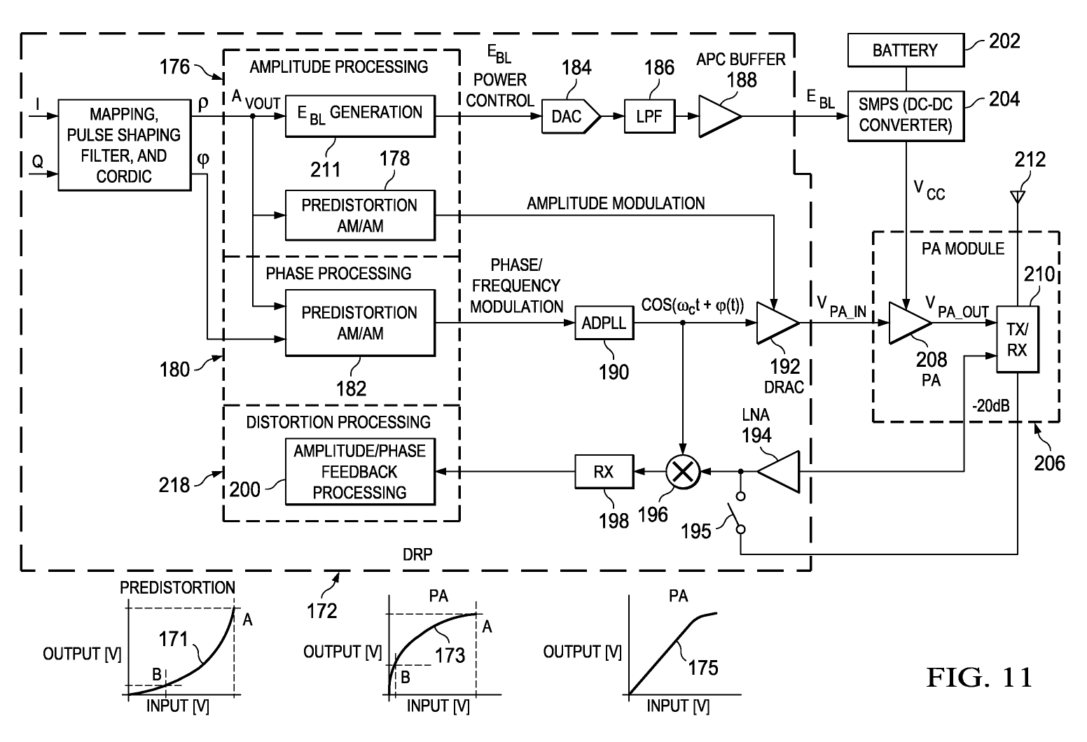

A block diagram illustrating an example embodiment of the power efficient transmitter of the present invention is shown in FIG. 11. The transmitter, generally referenced 170, comprises a DRP block 172, PA module 206, switched mode power supply (e.g., switching regulator) 204, attenuator 214, battery 202 and antenna 212. The PA module comprises a power amplifier 208 and TX/RX switch 210. The DRP block 172 comprises processing block 174 which performs mapping, pulse shaping, filtering and CORDIC functions, amplitude processing block 176 comprising E_{BL} generation block 211, AM/AM predistortion block 178, phase processing block 180 comprising AM/PM predistortion 182, distortion processing block 218 comprising amplitude and phase feedback processing block 200, digital to analog converter (DAC) 184, lowpass filter (LPF) 186, APC buffer 188, ADPLL 190, Digital to RF Amplitude Conversion (DRAC) 192, low noise amplifier (LNA) 194, multiplier 196, receiver (RX) circuit 198 and distortion processing 200.

The power efficiency improvement mechanism of the invention leverages the high efficiency of a switched-mode power supply (SMPS) 204 that supplies the high DC current to the transmitter's power amplifier 208, while compensating for its drawbacks using predistortion. The predistortion may be achieved using any suitable technique such as digital signal processing, hardware techniques, etc. In the example embodiment presented herein, the predistortion is generated using the computing resources of the DRP. The drawbacks of using a switching power supply include primarily the switching noise created by the SMPS and the degraded efficiency at high rates of switching, which is needed to accommodate wide bandwidth input signals.

It is noted that traditionally, either (1) power amplifiers powered by a SMPS are fully saturated, in which case the SMPS must produce a waveform that corresponds with the desired RF envelope, or (2) the SMPS produces a DC voltage that is sufficiently higher than the peak value of the envelope. The latter is done either (1) while maintaining enough backoff to avoid distortion altogether or (2) by reducing the backoff to the extent that some predictable and correctable distortion is suffered.

In accordance with the invention, the SMPS is operative to follow a reduced-bandwidth form of the desired envelope signal (E_{BL}), such that it may be accommodated by a lower rate of switching in the SMPS for which higher efficiency is achievable. This reduced bandwidth form of the envelope signal is typically not produced by simple linear low pass filtering of the desired envelope signal A_{VOUT}, but typically involves a nonlinear function. For example, the nonlinear function can completely ignore certain “valleys” in the signal (which occur at the lower amplitudes) for the sake of bandwidth reduction using a limiting or thresholding criteria whenever doing this would not result in significant losses in efficiency.

In a first embodiment, sufficient headroom is maintained in the linear power amplifier such that the reduced-bandwidth envelope signal is used alone (i.e. without any predistortion) to improve power efficiency. In this embodiment, the linear power amplifier is configured to have sufficient headroom to minimize any saturation/distortion.

In a second embodiment, the reduced-bandwidth envelope signal is used in combination with some type of pre-compensation. The compensation is used to compensate for supply-dependent distortions suffered in the power amplifier as a result of the headroom occasionally being too low to maintain perfect linearity (particularly around the highest peaks in the envelope). Compensation comprises amplitude and phase predistortions that are applied to the PA input signal. The predistortions may be implemented either (1) using a look up table (LUT) populated with predistortion correction values; or (2) a polynomial or equivalent that is calculated to determine the appropriate predistortion to apply for a particular input.

In the second embodiment, the digital signal processing portion of the mechanism of the invention accounts for the supply-dependent distortions suffered in the power amplifier and compensates for them by predistorting the PA input signal in a feed-forward manner. The predistortion is required to compensate for the variation in power amplifier characteristics (e.g., gain and phase response) due to continuous variation in V_{CC}.

It should be noted that in this second embodiment, the predistortion may comprise a two-dimensional function, since the input voltage signal alone may be not enough to determine the amount of distortion that would be experienced in the PA. This is because the supply value to the PA at that instance also depends on the envelope values at surrounding instances, and this supply value, corresponding to the present input voltage signal, would also have to be considered in the instantaneous compensation.

In a third embodiment, a form of feedback, based on continuous monitoring and detection of the power-amplifier's output signal, is used to adjust the envelope and phase of the internal modulation, and possibly also the envelope used for the supply modulation (i.e. the signal applied at the input to the regulator). Although an efficient negative feedback system may substitute for the feed-forward predistortion altogether, in the presence of reasonably accurate feed-forward predistortion, the errors for the feedback system would be reduced and the finite suppression offered by the feedback system for these errors will be able to meet the requirements of the particular wireless standard with less effort (e.g., reduced bandwidth in the closed-loop control system). In this case, circuitry, computation and energy efficiency may be optimized as the effort is distributed between the two paths.

The end result for the system is that the desired RF performance is obtained for the transmitter (i.e. desired levels of modulation distortion and spectral emissions) while achieving a significant improvement in overall efficiency. In addition, the implementation complexity of the switching supply is reduced on account of increased implementation complexity on the digital signal processing side. It is noted that any added power dissipation created by a more complex system (i.e. additional signal processing requirements) should be taken into account wherein the overall efficiency optimization considers all parts of the system, i.e. the small-signal SoC, where the predistortion and feedback processing takes place, in addition to the PA and SMPS, which are typically external to it. In most cases, however, the power consumed by a small-signal SoC in implementing predistortion and feedback processing is much smaller due to its use of a low voltage CMOS processes.

The invention focuses on generating E_{BL} from estimated A_{Vout} such that the average headroom at the output of the linear power amplifier is minimized while maintaining the following conditions:
a. E_{BL} is band-limited to frequency f_{c} such that E_{BL} does not cause excessive losses in the DC-DC converter.
b. f_{c}<f_{A} where f_{c} denotes the bandwidth of E_{BL}, f_{A} denotes the bandwidth of A_{Vout}; f_{c} will typically be an order of magnitude lower than f_{A} and f_{c} is selected according to the efficiency tradeoffs as described above.
c. V_{CC}-A_{VOUT}−Υ>0 at all times to avoid output clipping; σ is the minimum headroom requirements which is dependent on the particular characteristics of the power amplifier.

In the mechanism of the invention, the switched mode power supply (i.e. switching regulator) 204 is used to provide a slow form (i.e. reduced bandwidth) of envelope tracking (based on a narrower bandwidth distorted version of the envelope waveform) such that the switching regulator can use a lower switching rate corresponding to the lower bandwidth, thereby obtaining high efficiency in the regulation.

A consequence of the reduced bandwidth envelope signal is that the envelope tracking headroom varies from one instance to another. This results in varying amounts of AM-AM and AM-PM distortions in the power amplifier (PA). The mechanism of the invention compensates these distortions through predistortion of the digital amplitude modulating signal which dictates the envelope at the PA input (i.e. the internal amplitude modulation). Similarly, the internal phase modulation is also compensated internally.

The reduced-bandwidth envelope signal is generated by the E_{BL} generation circuit 211. The digital E_{BL} signal is converted to analog by DAC 184, with any replicas filtered by the low pass filter 186 and input to a buffer 188 before being input to the switching regulator 204. The regulator generates the V_{CC} provided to the linear power amplifier 208.

The operations performed are illustrated in graphs 171, 173 and 175. The predistortion curve applied to the input signal for all input code values is shown in graph 171. The distortion exhibited by the power amplifier versus the input amplitude is shown in graph 173. Finally, graph 175 shows the substantially linear final output/input curve of the power amplifier with the predistortion applied to the input signal.

It is also noted that the mechanism of the present invention is not limited to polar implementation but may also be implemented in a transmitter employing quadrature modulation, in which case the amplitude and phase compensation/predistortion is converted into the corresponding compensation in the I and Q branches. This DSP based approach is easily accommodated in CMOS DRP based architectures

It is further noted that a delay may need to be added in the modulating signal path, since the low pass filtered version of the envelope waveform that controls the switching regulator is lagging. The delay may be implemented in the digital domain utilizing simple digital buffering, wherein fine tuning of the delay to fractions of clock cycles can be obtained through digital filtering/interpolation without requiring higher sampling rates. In similar fashion, if the filtered version of the envelope waveform is leading the modulating signal, delay can be added at the input of DAC 184 on the envelope waveform path before it is converted to an analog signal.

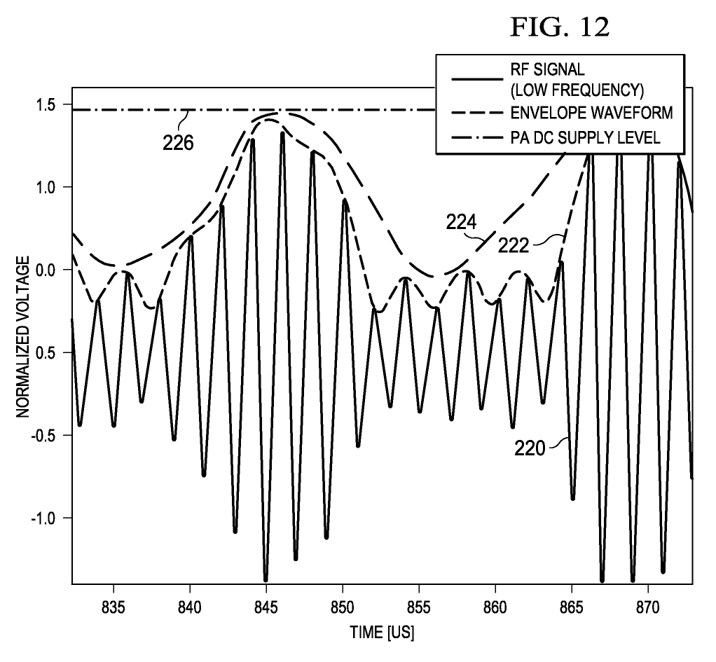

A graph illustrating the distorted/filtered version of the RF envelope generated by the power efficiency improvement mechanism versus an original prior art envelope is shown in FIG. 12. The graph shows the normal DC supply voltage 226 to the power amplifier 208, the RF signal 220 (a low frequency version is shown for clarity sake), a high bandwidth envelope signal 222 that tightly hugs the RF signal and is suitable for regulating the voltage for a saturated PA and a reduced bandwidth envelope signal 224 (dashed trace) that maintains headroom for operation with a linear PA in accordance with the present invention. The reduced-bandwidth envelope signal is generated by the E_{BL} generation circuit 211 and in accordance with the present invention, is fed to the V_{CC} supply voltage input of the power amplifier 208. This band-limited envelope signal 224 is significantly less demanding than signal 222, thus enabling the switching regulator to follow it much more easily.

Regarding the prior art, it is noted that the full-bandwidth envelope signal 222 is needed in the case of a fully saturated power amplifier. In performing modulation using a saturated power amplifier, the voltage for the saturated power amplifier is regulated according to the envelope signal that is to be created. The power amplifier is fed with a high enough signal at its RF input to constantly maintain saturation where the saturation level in terms of voltage is dictated by the voltage supplied to it from the regulator 204. In accordance with the invention, however, the power amplifier is not operated at full saturation. Instead, the power amplifier is operated with sufficient headroom such that there exists some potential power supply rejection ratio (PSRR) between the reduced-bandwidth envelope signal 224 and the RF signal 220, which is advantageous when the supply voltage originates from a noisy SMPS. The envelope signal fed to the supply input of the power amplifier 224 is a slower, band-limited version of the full-bandwidth envelope signal 222.

Thus, the invention addresses two problems, namely that of switching regulator noise and of bandwidth limitation in the switched regulator and its tradeoff with efficiency. The bandwidth problem is addressed by reducing the bandwidth of the envelope signal that is fed into the switching regulator. The envelope fluctuations needed, however, are dictated by the modulation scheme. The noise problem is addressed by operating the power amplifier close to saturation but not fully saturated. A voltage is provided to the power amplifier that is slightly higher than what is expected to be produced at the output of the power amplifier in the form of RF. The power amplifier, not permitted to rail as would a perfectly saturated amplifier, then provides some PSRR. Operating the power amplifier below the saturation point does, however, sacrifice a small amount of efficiency, since the power amplifier is most efficient when it is fully saturated.

Thus, the mechanism of the invention leaves some headroom so that the output signal does not reach the PA supply rails. Thus, the invention sacrifices some small amount of efficiency to gain some PSRR. The PSRR gained, however, is beneficial in that it helps to significantly suppress the noise generated by the switching regulator. Having PSRR is especially beneficial in the case of a potentially dirty supply, which would be the case in a switching regulator scenario.

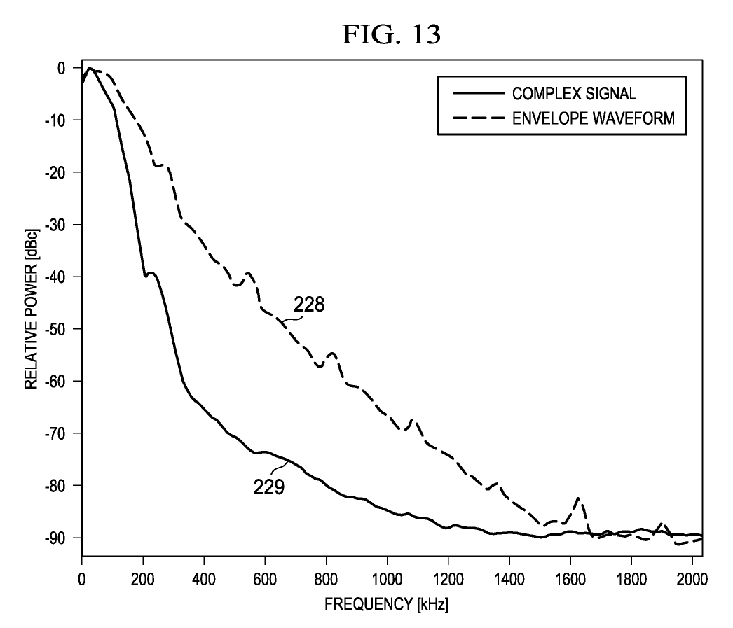

A graph illustrating the power spectral density of the complex input signal and the related envelope waveform is shown in FIG. 13. Trace 229 represents the normalized spectrum of I+jQ (i.e. the complex envelope), which is fairly well behaved in accordance with the pulse shaping function. In contrast, the normalized spectrum of the absolute envelope (trace 228) is wide due to the nonlinear relationship amplitude=\sqrt{I²+Q²}. For a wider bandwidth system, the envelope bandwidth may be even wider and more challenging to track.

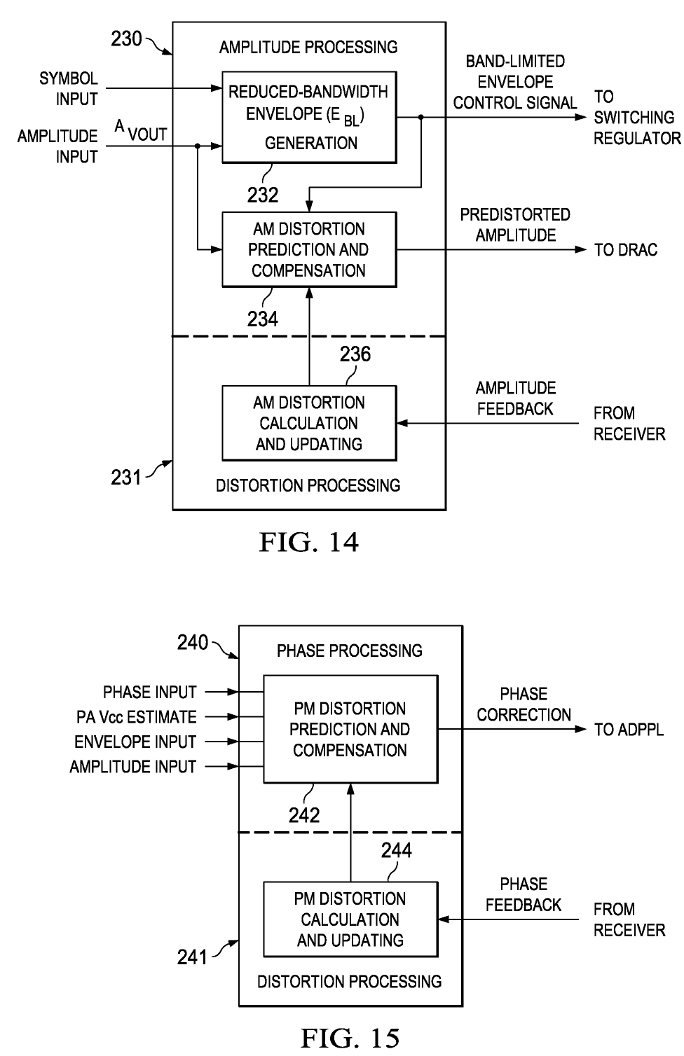

A block diagram illustrating the amplitude processing components of the power efficient transmitter of the present invention in more detail is shown in FIG. 14. The amplitude processing block, generally referenced 230, comprises envelope band limiting block 232 and AM distortion and prediction and compensation block 234. The distortion processing block 231 comprises AM distortion calculation and updating block 236.

In operation, symbol and amplitude signals are input to the amplitude processing block 230. The symbol input can be used in a possible embodiment of the invention to predict the future values of the amplitude signal resulting in better envelope generation with a reduced memory buffer due to the reduced need for storage of the amplitude signal. The envelope generator block 232 functions to generate the reduced-bandwidth envelope signal E_{BL} used by the switching regulator in generating the supply voltage to the power amplifier, based on the symbol and amplitude A_{VOUT} signal inputs. The AM distortion prediction and compensation block 234 functions to apply the appropriate AM/AM predistortion to the amplitude code input to the DRAC circuit. This is the compensation to be applied to the input signal to compensate for the distortion normally present in the power amplifier. The AM distortion calculation and updating block 236 receives amplitude feedback information from the receiver and, in response, determines the appropriate distortion and updates either the LUT or polynomial function used to calculate the predistortion to apply to the input signal. The operation of blocks 232, 234, 236 are described in more detail infra.

A block diagram illustrating the phase processing components of the power efficient transmitter of the present invention in more detail is shown in FIG. 15. The phase processing block, generally referenced 240, comprises PM distortion prediction and compensation block 242. The distortion processing block 241 comprises PM distortion calculation and updating block 244.

In operation, the phase, the power amplifier V_{CC} estimate and the amplitude input based envelope signal are input to the phase processing block 240. The PM distortion prediction and compensation block 242 functions to apply the appropriate AM/PM predistortion to the phase/frequency code input to the ADPLL. The PM distortion calculation and updating block 244 receives phase feedback information from the receiver and, in response, determines the appropriate distortion and updates either the LUT or polynomial function used to calculate the distortion to apply to the input signal. The operation of blocks 242, 244 are described in more detail infra.

### Generation of the Band-Limited Envelope Signal E_{BL}

The generation of the band-limited envelope signal E_{BL} may be realized in many different ways depending on the properties of the addressed modulation scheme and the bandwidth of the SMPS. In a multi mode transmitter, where different modulation schemes are addressed, different modes of operation for this function may be realized, each optimized for its targeted modulation scheme. An example implementation is provided below for illustration purposes.

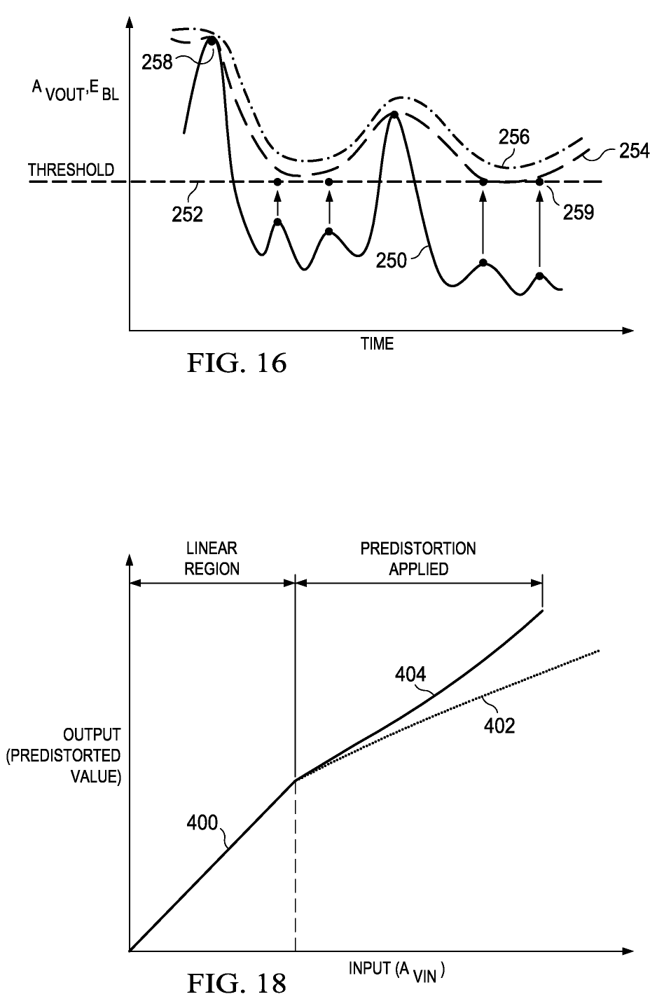

One possible example implementation of the E_{BL} generation function is based on a peak detector function that detects the local maxima points in the envelope signal. A graph illustrating the desired envelope signal and the final band-limited interpolated signal resulting from the generation of the reduced-bandwidth envelope signal E_{BL} is shown in FIG. 16. Illustrated are the desired envelope signal (trace 250), a plurality of local maximum points 258, a plurality of replacement points 259, the interpolation result (trace 254) and the interpolation signal with DC added resulting in the final E_{BL} output signal (trace 256).

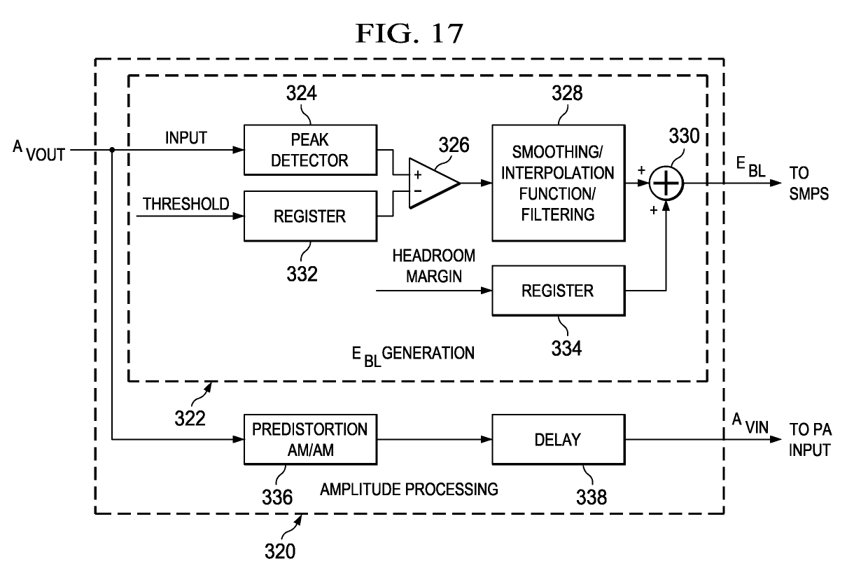

A block diagram illustrating an example embodiment of the reduced bandwidth envelope signal generator circuit of the present invention is shown in FIG. 17. The amplitude processing block 320 (176 in FIG. 11) comprises E_{BL} generation block 322, AM/AM predistortion block 336 and delay 338. The amplitude processing block 320 is operative to generate the reduced-bandwidth envelope signal E_{BL} input to the switching regulator 204 (FIG. 11) and the predistorted amplitude signal A_{VIN} input to the PA. The E_{BL} generation block 322 comprises peak detector 324, threshold comparator 326, smoothing/interpolation function/filtering block 328, adder 330, threshold configuration register 332 and headroom margin register 334.

With reference to FIGS. 16 and 17, the example implementation of the E_{BL} generation function is based on peak detector block 324 function that detects the local maxima points 258 in the envelope signal 250. By applying a configurable nonlinear threshold function (configured and stored in register 332), all peaks below the configured threshold level 252 are replaced with a fixed value (replacement points 259) that represent a high enough voltage to accommodate them. This threshold may depend on one or more factors, such as the power level for the packet being transmitted, the modulation scheme used, properties of the PA and the SMPS, etc.

Then, by means of a smoothing function, interpolation function, filtering function or polynomial interpolation function 328, the sequence of extracted peaks are ‘connected’ to form a waveform 254 of lower bandwidth that serves to accommodate all the peaks in the envelope signal. A constant (configured and stored in register 334) may be added (via adder 330) to guarantee a minimal headroom, particularly for the first embodiment of the invention, where predistortion is eliminated altogether. Alternatively, the offset addition may be replaced with a multiplication function whereby the headroom would depend on the instantaneous amplitude being accommodated. Additionally, causality is addressed by applying the appropriate amount of delay to the signal path where the input signal to the PA is applied in order for the E_{BL} signal not to appear lagging and to timely accommodate the peaks in the A_{VIN} signal and the corresponding A_{VOUT} signal. The delay is introduced via delay block 338 after the AM/AM predistortion block. Alternatively, the delay can also be added on the E_{BL} path if the E_{BL} is leading with respect to the amplitude signal.

### Dynamic Predistortion

Typically, a power amplifier (PA) may experience a certain extent of nonlinearity depending on its characteristics and the input signal. This nonlinearity can be characterized by deviation from the linear output/input curve, typically denoted the AM/AM distortion of the PA, and by amplitude-dependent phase shifts, typically denoted AM/PM. The amplitude and phase errors represented by the AM/AM and AM/PM distortion can be compensated for by determining the dependency and constructing a sufficiently accurate inverse of this curve, which is then used to predistort the signal prior to the distortion it suffers in the PA. It is more practical to predistort the signal at the input of the PA rather than applying compensation for the distortion at its output because the signal level at the PA output is relatively high, making it difficult to process such signals, while losses in such processing cannot be tolerated from a power-efficiency point of view.

In many cases, the predistortion function, which is realized using a polynomial, look-up-table (LUT) or any other suitable technique, only needs the amplitude information to compute the necessary predistortion. Note that although the distortion in the PA may be temperature and frequency dependent as well, for a given duration (e.g., short packet of data), the distortion, and hence the corresponding predistortion function, may be considered static (i.e. a function of the amplitude only).

Practically, however, the distortion depends not only on the input amplitude but also on the supply voltage. Linear power amplifiers, however, are typically used with a fixed power supply even when this supply is adjusted in accordance to the signal level being transmitted for a particular burst, such as in packetized transmission. In continuous transmission, such as in a WCDMA system, the power supply for the PA may be adjusted dynamically according to the power level that is determined by the propagation losses between a mobile device and a base station. Such dynamic adjustment, however, would typically still allow enough headroom in the power amplifier (i.e. to avoid saturation) such that no distortion would be suffered. If distortion is suffered, however, it may still be considered static in that the rail defined by the supply would remain static for a long enough duration with respect to the bandwidth of the envelope. This eliminates the need to perform predistortion calculations at rates that correspond to the bandwidth of the envelope signal.

In accordance with the invention, the supply provided to the PA is adjusted dynamically, but does not follow the envelope of the amplitude signal very tightly, since it is not used to actually generate the amplitude modulation as is the case in prior art saturated PA based schemes. Rather, the supply only follows the envelope approximately in order to minimize voltage headroom that would otherwise result in wasted power. In the example polar based embodiment presented herein, the modulation is accomplished in a stage prior to the power amplifier in the pre-power amplifier (PPA) or DRAC 192 (FIG. 11). In this case, the PA operates as a linear amplifier or a closely linear amplifier, depending on the minimal headroom that is maintained by the system of the present invention.

In one embodiment of the invention, the band-limited envelope tracking signal E_{BL} is kept sufficiently above the signal A_{Vout}, which represents the varying amplitude of the output signal, such that the remaining headroom guarantees substantially linear performance with no intolerable degradation suffered in the PA. In this embodiment, no predistortion of the input amplitude or phase is performed. For example, in a GSM/EDGE system, where an amplitude varying scheme is used during the transmission of data in accordance with EDGE (i.e. 3π/8-8PSK modulation), a headroom of 6 dB between the signal's power (i.e. average power, peak power, etc.) and the 1 dB compression point of the amplifier is often used.

Depending on the modulation scheme and the spectral mask requirements of the particular system, a different headroom may be needed to guarantee compliance with the requirements of the system without necessitating predistortion. The power headroom may be translated into a voltage headroom, given the impedance of the load to which the output power is delivered. In this embodiment, since the headroom is sufficient to prevent distortion that may require predistortion, the predistortion not only reverts to what was defined above as ‘static’, i.e. depends only on the input amplitude and not on the voltage supply to the PA, but the predistortion is eliminated altogether.

In this first embodiment, the predistortion function for the phase and amplitude of the modulated signal may be represented as ‘static’ functions of the form:

φ=g_{AM-PM}(A_{VIN})

α=h_{AM-AM}(A_{VIN}) (8)

where
φ represents the phase correction that would need to be applied to the phase-modulation signal in order to compensate for a phase shift of that magnitude, which the PA introduces as the amplitude of the signal at its input A_{VIN}; and
α represents the predistortion factor to be applied to the amplitude signal in the amplitude modulation function, such that once the distortion is suffered in the PA, the end result is as close as possible to the desired amplitude.

In a second embodiment of the invention, the headroom is maintained high for the lower values of the envelope tracking signal while for the highest values of the envelope tracking signal, where the dissipated power is typically higher, a lower headroom is used, resulting in distortion that may require predistortion of the input signal. Such a scheme is advantageous since the efficiency in terms of percents is not necessarily the parameter of greatest interest. Rather, the actual dissipated (i.e. wasted) power may be the parameter of greatest interest. Thus, at lower power levels, lower efficiency percentages are tolerable, whereas the efficiency at high power levels has a greater impact on the total power dissipation.

In this second embodiment, although the headroom for a particular low value of amplitude may vary depending on the envelope signal A_{Vout}, the headroom is kept high enough to maintain the linearity and simplify the predistortion function. At higher levels, the envelope signal E_{BL} is reduced, resulting in nonlinearity that requires predistortion. The predistortion computation for each instance requires not only the input amplitude at that instance, but also the PA supply voltage defined by the band-limited envelope tracking signal E_{BL}. This second embodiment is more power efficient since the instances of higher power dissipation are addressed by dynamic reduction in the headroom accompanied by predistortion.

It is noted that the first embodiment, when compared to the second embodiment, (1) has the advantage of reduced complexity and (2) already offers a significant improvement in efficiency, as it greatly reduces the power dissipation in the PA during the durations when the output power is low and the headroom would have otherwise been unnecessarily high.

In the second embodiment of the invention, the predistortion function depends not only on the input signal A_{VIN} but also on the headroom (or alternatively the band-limited envelope signal E_{BL}), and is represented in the general form as:

φ=g_{AM-PM}(A_{VIN},E_{BL})

α=h_{AM-AM}(A_{VIN},E_{BL}) (9)

The implementation of the two-dimensional predistortion functions g and h of the second embodiment is not critical to the invention. Any suitable technique may be used, such as one based on polynomials, one or more look-up tables (LUTs) or any other means for mapping the input pair {A_{VIN},E_{BL}} to the output pair {φ,α}. If the headroom is maintained sufficiently high for a region of input amplitudes for which there is little benefit in tightening the headroom, a threshold function may be applied to determine when predistortion is to be computed. In a look-up table (LUT) based implementation, this serves to reduce the size of the required look-up table. In a polynomial/computation based implementation, this serves to reduce the number of computations in a given duration, potentially resulting in the reduction of current consumption and complexity.

A graph illustrating an example single dimension predistortion function with a threshold is shown in FIG. 18. Note that a general single-dimension predistortion function (g or h) with a threshold is shown. In this example, the headroom is maintained sufficiently high in the linear region 400 thus eliminating the need for predistortion. Thus, the linear region represents the range of the input amplitude Aᵥᵢₙ for which no predistortion needs to be computed. When the input exceeds the threshold 401, predistortion 404 is applied to compensate for the PA distortion 402.

Note that in the two dimensional case, the linear curve is represented by a sloped plane (and not a line) since it is dependent on the input amplitude Aᵥᵢₙ but not on the headroom or band-limited envelope signal E_{BL}. The remaining area for the two-dimensional case would be formed according to the distortion's dependency upon its input variables Aᵥᵢₙ and E_{BL}.

In a third embodiment, as described supra, rather than use predistortion to compensate for the reduced-bandwidth envelope signal, a form of feedback, based on continuous monitoring and detection of the power-amplifier's output signal, is used to adjust the amplitude and phase of the internal modulation, as well as the envelope used for external modulation (i.e. the signal applied at the input to the regulator). Although an efficient negative feedback system may substitute for the feed-forward predistortion altogether, in the presence of reasonably accurate feed-forward predistortion, the errors for the feedback system would be reduced and the finite suppression offered by the feedback system for these errors will be able to meet the requirements of the particular wireless standard with less effort. In this case, circuitry, computation and energy efficiency would be optimized as the effort is distributed between the two paths.

It is noted that the circuitry used for the purpose of providing the monitoring of the PA output signal may be substantially that of the existing receiver (as shown in FIG. 11) but may also comprise dedicated circuitry for envelope detection and for phase detection (if phase errors are to be measured and compensated as well). This is particularly valid where the system may not comprise receiver circuitry or, if it does, may not be available for use during transmission, as is the case in FDD systems such as WCDMA.

### Calibration of the Dynamic Predistortion Function

In order to characterize the two-dimensional function for the predistortion, the output amplitude and phase, which would be predistorted using the h and g functions respectively, must be measured/characterized for regions of interest in the plane defined by the input pair {Aᵥᵢₙ, E_{BL}}. Any suitable method of accomplishing this may be used. An example technique is presented hereinbelow.

The characterization is accomplished by sweeping though the plane by applying ramp signals to the A_{VIN} and E_{BL} outputs of the transceiver such that the PA experiences a sufficient number of points on a grid defined a priori based on areas of interest in the function (different densities may be used in different regions based on the shape of this function). Note that for a look-up table based implementation, the predistortion function does not necessarily need to be calibrated for each entry in the table but may rather rely on interpolation of results obtained during the calibration process. In a polynomial based implementation, the coefficients of the polynomial may be determined based on the points at which the function is sampled.

The measurements of the output amplitude and phase to be used for calibration purposes may be obtained either internally, as described in U.S. application Ser. No. 11/675,582, filed Feb. 15, 2007, entitled “Linearization of a Transmit Amplifier”, incorporated herein by reference in its entirety, or may be obtained during a characterization phase where external test-equipment is used to accurately measure the distortion, such as during a one-time calibration procedure performed at the time of manufacture, in which case the results would have to be stored in nonvolatile memory for subsequent retrieval.

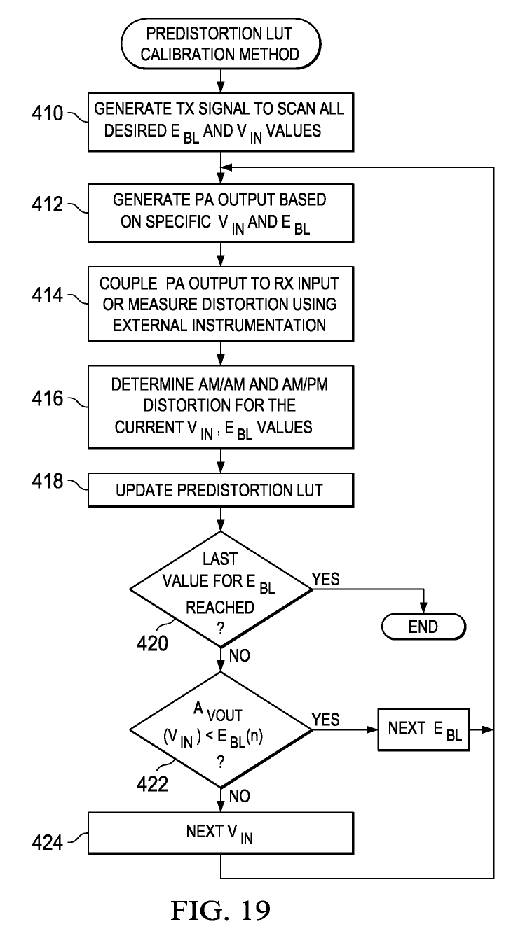

A flow diagram illustrating an example predistortion LUT generation method of the present invention is shown in FIG. 19. The controller scans through the range of values for E_{BL} and V_{IN} to perform a two-dimensional scan (step 410). All or a portion of the dynamic range is covered in a plurality of digital amplitude modulation steps. Since the CORDIC 174 (FIG. 11) is typically frozen during this procedure, these steps can be applied using script processor write operations at the Ramp/Gain Normalization Port. Note that the DRAC dynamic range can be covered in either equal spaced or exponentially spaced (preferred) intervals depending on the requirements. Using too few points at lower power levels may render the predistortion quantization level too coarse at lower power levels.

For each code or step, TX I/Q data is generated and input to the TX. Assuming the predistortion LUT has not been populated yet as is the case during IC manufacture, the TX data is translated by the DRAC into a TX output signal having a certain amplitude. The TX output signal is input to the power amplifier in the FEM which functions to amplify the input signal to generate an RF output signal based on specific E_{BL} and V_{IN} values (step 412).

In order to characterize the distortion introduced by the power amplifier, the RF output signal is fed back to the RX chain via coupler 210 to LNA 194 or, alternatively, is output to external instrumentation (step 414). Depending on the signal level, an attenuated signal is used via attenuator 214 and switch 195. The signal then is input to the receiver 198 via mixer 196. The manner of coupling of the RF output signal may be implemented using suitable means and is not critical to the invention. The coupled RF output signal is demodulated by the RX chain and the I and Q samples are recovered. The recovered I and Q samples are processed by the amplitude/phase feedback processing block 200 in the distortion processing block 218 and the amplitude (AM/AM) and phase (AM/PM) distortion values for the current E_{BL} and V_{IN} values is determined (step 416). The distortion values are then used to compute and populate the predistortion LUTs in blocks 178, 180 (step 418).

If the last value for E_{BL} has been reached (step 420), then the method ends. Otherwise, if A_{VOUT}(V_{IN})<E_{BL}(n) (step 422) then the method continues with the next V_{IN} (step 424). If the comparison in step 422 is not true, then the next E_{BL} is selected (step 426). This is because there is no need to ramp the input signal V_{IN} above the value that the supply input V_{CC} of the PA can handle.

It is noted that a two-dimensional scan (i.e. E_{BL}, V_{IN}) does not necessarily span a rectangle. Since the input signal V_{IN} does not need to be ramped above the value that the supply input V_{CC} of the PA (i.e. E_{BL}) can support, the range that is to be scanned resembles more of a triangle. As an example, a sample pseudo-code listing illustrating the calibration processing with a two-dimensional scan is provided below in Listing 1.

Listing 1: Predistortion Calibration with Two-Dimensional Scan

```
for E_{BL} values of n = 2, 2.4, 3.1, 3.2, 3.5, 3.7;
  sweep V_{IN} in steps that satisfy: A_{VOUT}(V_{IN}) = 0.3, 0.7, 1.2, 1.7,
  2.4, 2.5, 2.6, 2.7, 3.1, 3.2, 3.3, 3.4;
  generate the PA output;
  couple the PA output to the RX input or use external instrumentation;
  determine the AM/AM and AM/PM distortion for the current V_{IN},
  E_{BL} values;
  if A_{VOUT}(V_{IN}) < E_{BL}(n) then
  next V_{IN} step;
next n (E_{BL} step);
```

After manufacture and during operation of the chip, the contents of the predistortion LUT may be updated by closing the loop to generate new predistortion values. The new values replace the contents of the predistortion LUT. In the case of GGE (GSM/GPRS/EDGE) systems, the updates could also occur during the ramp up or ramp down of the GGE burst transmission, as well as during the transmission of data, as the desired value of the instantaneous amplitude phase is deterministic. Generating the predistortion values may be crucial to compensating for variations in operating characteristics such as temperature, battery voltage, frequency of operation and variations in antenna load causing VSWR.

The above procedure is to be repeated for various PA supply voltages of interest which may be provided as a ramp/staircase function or any other function produced at the E_{BL} output.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of improving power efficiency of a transmitter having a linear power amplifier, said method comprising the step of:
generating a reduced bandwidth envelope signal for input to a switched mode power supply, the output of said switched mode power supply applied to the supply input of said linear power amplifier; and
wherein said linear power amplifier is operated in a non-saturated mode.

2. The method according to claim 1, wherein the average headroom of said reduced bandwidth envelope signal is minimized.

3. The method according to claim 1, wherein said reduced bandwidth envelope signal yields sufficient headroom in said linear power amplifier such that compensation for power supply dependent distortions in said linear power amplifier is not required.

4. The method according to claim 1, wherein said reduced-bandwidth envelope signal provides a relatively slow form of envelope tracking that does not fully track said power amplifier input.

5. The method according to claim 1, wherein said switched mode power supply comprises a switching regulator.

6. The method according to claim 1, wherein said switched mode power supply is operated at a relatively low switching rate thereby maximizing efficiency.

7. A method of improving power efficiency of a transmitter having a linear power amplifier, said method comprising the steps of:
generating a reduced bandwidth envelope signal for input to a switched mode power supply, the output of said switched mode power supply applied to the supply input of said linear power amplifier, wherein said linear power amplifier is operated in a non-saturated mode; and
compensating for power supply dependent distortions in said linear power amplifier to yield a substantially linear output therefrom.

8. The method according to claim 7, wherein said step of compensating comprises predistorting the signal input to said linear power amplifier.

9. The method according to claim 8, wherein said step of predistorting the input signal to the linear power amplifier comprises the steps of:
stepping through a dynamic range of inputs for said power amplifier;
generating a radio frequency (RF) input signal in response thereto; and
characterizing the RF output of said power amplifier to calculate a plurality of predistortion values and storing said values in a predistortion look up table (LUT) in accordance therewith.

10. The method according to claim 8, wherein said step of predistorting the input signal to the linear power amplifier comprises the steps of:
stepping through a dynamic range of inputs for said power amplifier;
generating a radio frequency (RF) input signal in response thereto; and
characterizing the RF output of said power amplifier to determine a correction polynomial in accordance therewith.

11. The method according to claim 7, wherein said step of compensating comprises providing closed loop feedback of the output of said linear power amplifier to adjust amplitude and phase of modulation performed within said transmitter.

12. The method according to claim 7, wherein said reduced-bandwidth envelope signal provides a relatively slow form of envelope tracking that does not fully track the envelope at said power amplifier input.

13. The method according to claim 7, wherein said switched mode power supply comprises a switching regulator.

14. The method according to claim 7, wherein said switched mode power supply is operated at a relatively low switching rate thereby maximizing efficiency.

15. The method according to claim 7, wherein said step of compensating comprises applying amplitude and phase domain predistortion to said linear power amplifier input signal, wherein said predistortion is a function of said linear power amplifier input signal and said reduced bandwidth envelope signal.

16. The method according to claim 7, wherein said supply dependent distortions comprise amplitude and phase distortions.

17. The method according to claim 7, wherein said power amplifier is operated below its saturation point.

18. A method of improving power efficiency of a transmitter incorporating a linear power amplifier and switching regulator, said method comprising the steps of:
generating a slowed envelope tracking signal such that a switching rate corresponding to a lower bandwidth than that of a signal input to said linear power amplifier can be used by said switching regulator;
pre-distorting an amplitude modulating signal input that determines the envelope at the power amplifier; and
wherein said linear power amplifier is operated in a non-saturated mode of operation.

19. The method according to claim 18, wherein said step of predistorting the amplitude modulating signal input comprises the steps of:
stepping through a dynamic range of inputs of said power amplifier;
generating a radio frequency (RF) output signal in response thereto; and
sampling said RF output and calculating a plurality of predistortion values and storing said values in a predistortion look up table (LUT) in accordance therewith.

20. The method according to claim 18, wherein said step of predistorting the amplitude modulating signal input comprises the steps of:
stepping through a dynamic range of inputs of said transmitter;
generating a radio frequency (RF) output signal in response thereto; and
sampling said RF output and determining a correction polynomial in accordance therewith.

21. The method according to claim 18, wherein said slowed envelope tracking signal provides a relatively slow form of envelope tracking that does not fully track said power amplifier input.

22. A method of improving the power efficiency of a transmitter incorporating a linear power amplifier and switching regulator, said method comprising the steps of:
generating a reduced bandwidth envelope tracking signal input to said switching regulator such that a switching rate corresponding to a lower bandwidth than that of a signal input to said linear power amplifier can be used, the output of said switching regulator input to the supply input of said linear power amplifier; and
pre-distorting the input to said power amplifier to compensate for supply-headroom dependent distortions in said power amplifier.

23. The method according to claim 22, wherein said step of pre-distorting comprises applying amplitude and phase domain predistortion to said linear power amplifier input signal, wherein said predistortion is a function of said linear power amplifier input signal and said reduced bandwidth envelope signal.

24. An apparatus for improving the efficiency of a digital transmitter incorporating a switching power supply and a linear power amplifier, comprising:
an envelope-tracking band limited signal generator operative to generate a band-limited envelope regulator control signal input to said switching power supply; and
wherein said linear power amplifier is operated in a non-saturated mode of operation.

25. The apparatus according to claim 24, further comprising a compensation module operative to apply a correction to the input to said power amplifier thereby compensating for power supply dependent distortions in said linear power amplifier.

26. The apparatus according to claim 25, wherein said compensation module comprises means for applying amplitude and phase domain predistortion to said linear power amplifier input signal, wherein said predistortion is a function of said linear power amplifier input signal and said reduced bandwidth envelope signal.

27. The apparatus according to claim 24, wherein said band-limited envelope regulator control signal yields sufficient headroom in said linear power amplifier such that compensation for power supply dependent distortions in said linear power amplifier is not required.

28. The apparatus according to claim 24, wherein said reduced-bandwidth envelope signal provides a relatively slow form of envelope tracking that does not fully track said power amplifier input.

29. A power efficient transmitter, comprising:
a transmit chain operative to generate an output transmit signal in accordance with a signal input thereto;
a switched mode power supply;
a linear power amplifier operated in a non-saturated mode; and
an envelope-tracking band limiter operative to generate a band-limited envelope control signal input to said switched mode power supply.

30. The transmitter according to claim 29, further comprising means for providing closed loop feedback of the output of said linear power amplifier to adjust amplitude and phase of modulation performed within said transmitter.

31. The transmitter according to claim 29, further comprising a compensation module operative to apply a correction to the input of said linear power amplifier, wherein a pre-distorted transmit signal is generated and input to said linear power amplifier thereby compensating for power-supply dependent distortions generated by said linear power amplifier.

32. The transmitter according to claim 31, wherein said compensation module comprises means for applying amplitude and phase domain predistortion to said linear power amplifier input signal, wherein said predistortion is a function of said linear power amplifier input signal and said band-limited envelope control signal.

33. The transmitter according to claim 29, wherein said band-limited envelope control signal provides a relatively slow form of envelope tracking that does not fully track a linear power amplifier input signal.

34. A radio, comprising:
a phase locked loop;
a transmitter coupled to said phase locked loop, said transmitter comprising:
a transmit chain operative to generate a output transmit signal in accordance with a signal input thereto;
a switched mode power supply;
a linear power amplifier operated in a non-saturated mode;
an envelope-tracking band limited signal generator operative to generate a band-limited envelope regulator control signal input to said switched mode power supply;
a receiver coupled to said phase locked loop; and
a baseband processor coupled to said transmitter and said receiver.

35. The radio according to claim 34, further comprising a compensation module operative to apply a correction to the input of said linear power amplifier, wherein a pre-distorted transmit signal is generated and input to said linear power amplifier thereby compensating for power-supply dependent distortions generated by said linear power amplifier;
